(19) United States
(12) Patent Application Publication
(10) Pub. No.: US 2007/0037093 A1
(43) Pub. Date: Feb. 15, 2007

(54) Information-recording medium

(75) Inventors: Makoto Miyamoto, Moriya-shi (JP); Reiji Tamura, Moriya-shi (JP); Akira Kashiwakura, Moriya-shi (JP); Hiroshi Shirai, Moriya-shi (JP); Yoshihiro Ikari, Moriya-shi (JP); Makoto Iimura, Shimotsuma-shi (JP); Yumiko Anzai, Oume-shi (JP); Kazuyo Umezawa, Sagamihara-shi (JP)

Correspondence Address: OLIFF & BERRIDGE, PLC, P.O. BOX 19928, ALEXANDRIA, VA, 22320, US

(73) Assignee: HITACHI MAXELL, LTD., Ibaraki-shi (JP)

(21) Appl. No.: 11/529,513

(22) Filed: Sep. 29, 2006

Related U.S. Application Data
(62) Division of application No. 10/656,337, filed on Sep. 8, 2003.

(30) Foreign Application Priority Data
Sep. 10, 2002 (JP) 2002-263570
Feb. 5, 2003 (JP) 2003-28620

(51) Int. Cl. G11B 7/24

(52) U.S. Cl. 430/270.13; 430/945; 428/64.5; 369/275.4; 369/275.2

(57) ABSTRACT

An phase-change optical disk comprises a substrate, a first protective layer, a first thermostable layer, a recording layer, a second thermostable layer, a second protective layer, an absorptance control layer, and a heat-diffusing layer which are provided in this order from a side on which a laser beam comes thereinto, wherein a recording layer material has composition ratios which are within a range surrounded by composition points of B3 (Bi₃, Ge₄₆, Te₅₁), C3 (Bi₄, Ge₄₆, Te₅₀), D3 (Bi₅, Ge₄₆, Te₄₉), D5 (Bi₁₀, Ge₄₂, Te₄₈), C5 (Bi₁₀, Ge₄₁, Te₄₉), and B5 (Bi₇, Ge₄₁, Te₅₂) on a triangular composition diagram. Recrystallization is not caused even when information is recorded on an inner circumferential portion, a reproduced signal is scarcely deteriorated even when rewriting is performed multiple times, and any erasing residue of amorphous matters scarcely appears at an outer circumferential portion.

This application is a Divisional of U.S. patent application Ser. No. 10/656,337, filed Sep. 8, 2003, which is hereby incorporated by reference it its entirety. This application claims priority to Japanese patent applications 2002-263570, filed Sep. 10, 2002, and 2003-028620, filed Feb. 5, 2003, both of which are hereby incorporated by reference in their entirety.

### BACKGROUND OF THE INVENTION

1. Field of the Invention

The present invention relates to an information-recording medium on which information is recorded by radiating an energy beam. In particular, the present invention relates to an optical disk such as DVD-RAM, DVD-RW, and DVD+RW adapted to the red laser and a phase-change optical disk such as Blu-ray adapted to the blue laser.

2. Description of the Related Art

In recent years, the market of read-only optical disks such as DVD-ROM and DVD-Video is expanded. Rewritable DVD's such as DVD-RAM, DVD-RW, and DVD+RW are introduced into the market. The market is being quickly expanded, as rewritable DVD's are used as the media for recording images in place of backup media for computers and VTR. In recent years, the market increasingly demands the improvement of transfer rate, the improvement of access speed, and the realization of large capacity for the recordable DVD.

The phase-change recording system is adopted for the recordable DVD medium such as DVD-RAM and DVD-RW on which information is recordable and erasable. In the phase-change recording system, the information of “0” and the information of “1” are basically allowed to correspond to the crystalline state and the amorphous state to perform the recording. Further, the refractive index differs between the crystalline state and the amorphous state. Therefore, the refractive indexes and the film thicknesses of the respective layers are designed so that the difference in refractive index is maximized between the portion changed to the crystal and the portion changed to the amorphous. The recorded “0” and “1” can be detected by radiating the laser beam onto the crystallized portion and the amorphous portion and performing the reproduction with the reflected light beam.

In order to obtain the amorphous state at a predetermined position (this operation is usually called “recording”), a laser beam having a relatively high power is radiated to effect the heating so that the temperature of the recording layer is not less than the melting point of the recording layer material. In order to obtain the crystalline state at a predetermined position (this operation is usually called “erasing”), a laser beam having a relatively low power is radiated to effect the heating so that the temperature of the recording layer is in the vicinity of the crystallization temperature which is not more than the melting point of the recording layer material. By doing so, the amorphous state and the crystalline state can be reversibly changed.

In order that the recordable DVD responds to the demand for the improvement of transfer rate, a method is generally used, in which the number of revolutions of the medium is increased to perform the recording and the erasing in a short period of time. In this procedure, a problem arises concerning the recording/erasing characteristics when information is overwritten on the medium. This problem will be explained in detail below.

It is assumed that the amorphous state is changed to the crystalline state at a predetermined position. When the number of revolutions of the medium is increased, then the period of time, in which the laser beam passes over the predetermined position, is shortened, and the period of time, in which the crystallization temperature is retained at the predetermined position, is simultaneously shortened as well. If the period of time, in which the crystallization temperature is retained, is too short, it is impossible to sufficiently effect the crystal growth. Therefore, the amorphous state consequently remains. This situation is reflected to the reproduced signal, and the quality of the reproduced signal is deteriorated.

In order to solve this problem, a method is known, which uses a material obtained by adding Sn to a Ge—Sb—Te-based phase-change recording material which has been hitherto generally used (see, for example, Japanese Patent Application Laid-open No. 2001-322357 (pp. 3-6, FIGS. 1-2)). In Japanese Patent Application Laid-open No. 2001-322357, a material is used as a recording material, which is obtained by adding a metal such as Ag, Al, Cr, and Mn to a Ge—Sn—Sb—Te-based material. Accordingly, an information-recording medium is obtained, on which the high density recording can be performed, the repeated rewriting performance is excellent, and the crystallization sensitivity less undergoes the time-dependent deterioration. Additionally, there is an example other than Japanese Patent Application Laid-open No. 2001-322357, in which a recording layer material based on the Ge—Sb—Sn—Te system is used (see, for example, Japanese Patent Application Laid-open No. 2-147289 (pp. 2-3, FIG. 1)).

Further, there is an example in which a Bi—Ge—Te-based phase-change recording material is used as a recording material (see, for example, Japanese Patent Application Laid-open No. 62-209741 (pp. 3-5, FIGS. 1-2)). In this document, a practical composition range of the Bi—Ge—Te-based phase-change recording material is prescribed. Additionally, there is an example as well in which a practical range of a Bi—Ge—Se—Te-based phase-change recording material is prescribed (see, for example, Japanese Patent Application Laid-open No. 62-73439 (pp. 3-8, FIGS. 1-2), and Japanese Patent Application Laid-open No. 1-220236 (pp. 3-8, FIG. 1)). Further, there is also an example in which a practical range of a Bi—Ge—Sb—Te-based phase-change recording material is prescribed (see, for example, Japanese Patent Application Laid-open No. 1-287836 (pp. 3-4)).

A Ge—Sn—Sb—Te material is reported as a recording material which is adaptable to the ×2 to ×4 speed recording on DVD-RAM (see, for example, Shigeaki Furukawa et al., “Advanced 4.7 GB DVD-RAM with a 4× Data Transfer Rate”, Proceedings of The 13th Symposium on Phase Change Optical Information Storage PCOS 2001), December, 2001, p. 55). Further, an information-recording medium is reported, which is adaptable to the ×2 and ×5 speed recording on DVD-RAM (see, for example, Makoto Miyamoto et al., “High-Transfer-Rate 4.7-GB DVD-RAM”, Joint International Symposium on Optical Memory and Optical Data Storage 2002 Technical Digest, July, 2002, p. 416). In this case, the ×5 speed medium realizes the ×5 speed recording by providing an eight-layered structure which is newly added with a nucleus-generating layer.

A method is well-known as a technique to realize a large capacity of the recordable DVD, in which information is recorded at a higher density by decreasing the laser spot diameter by shortening the wavelength of the laser beam to be 405 nm and increasing NA of the objective lens to be 0.85 (see, for example, Japanese Journal of Applied Physics, 2000, Vol. 39, pp. 756-761).

This method is utilized as a principal technique of so-called Blu-ray Disc. The influence, which is exerted on the disk tilt, is decreased by adopting a substrate of 0.1 mm which is thinner than those used for conventional DVD. The 0.1 mm substrate plays important roles including the mechanical protection and the electrochemical protection (prevention of corrosion) of the recording layer. The conventional rewritable medium such as DVD-RAM and DVD-RW has a stacked structure basically including a four-layered structure comprising a dielectric layer, a phase-change recording layer, a dielectric layer, and a reflective layer formed on a 0.6 mm polycarbonate (PC) substrate, which can be realized by stacking the 0.6 mm substrates with each other. However, in the case of the technique for realizing the large capacity, it is difficult to maintain the rigidity of the 0.1 mm substrate. Therefore, the substrate can be manufacture in accordance with a method in which a reflective layer, a dielectric layer, a phase-change recording layer, and a dielectric layer are stacked on a thick substrate, for example, on a 1.1 mm PC substrate in an order opposite to the order adopted in the conventional rewritable medium, and a 0.1 mm cover layer is finally formed as a protective layer.

An Ag—In—Sb—Te-based recording material can be used as a recording material for Blu-ray Disc (see, for example, Japanese Patent No. 2941848 (pp. 2-3)). In Japanese Patent No. 2941848, detailed descriptions are also made about a composition of a recording material which is obtained by adding a fifth element and a sixth element to the Ag—In—Sb—Te-based recording material.

The method, which has been suggested to form the cover layer as described above, includes a method in which a sheet having a thickness of 0.1 mm is stuck with a UV-curable resin adhesive, and a method in which a UV-curable resin is uniformly applied by means of the spin coat method, followed by being cured by means of irradiation with ultraviolet light to form the cover layer.

On the other hand, a method has been suggested, in which a medium comprising layers stacked in the same order as that of the conventional technique is manufactured on a 0.6 mm substrate to record information with a laser beam having a wavelength of 405 nm and with an objective lens having NA of 0.65. In this method, the laser spot diameter is large and the recording density is small as compared with the method in which the 0.1 mm cover layer is used as described above, because NA of the objective lens is small. However, this method is advantageous in that the rigidity of the substrate can be maintained, and the multiple layers can be formed for the recording layer with ease. Further, this method is advantageous in that the influence, which is exerted by the dust and the scratches on the disk, can be decreased.

In the techniques of, for example, DVD-RAM, DVD-RW, DVD+RW, and Blue-ray Disc as described above, the so-called wobble track is adopted, in which the recording track is meandered. For example, the address information and the synchronization signal are recorded on the wobble. The format can be effected highly efficiently by reproducing the recording signals with sum signals and reproducing the wobble signals with difference signals. The synchronization signal can be also obtained from the wobble signal. Therefore, this technique is known to be an extremely effective means for improving, for example, the reliability of the address information and the recorded information.

When information is recorded on the optical disk which adopts the phase-change recording system, the number of revolutions of the optical disk is usually controlled in accordance with the CLV (Constant Linear Velocity) system. That is, in this control method, the relative velocity between the laser beam and the optical disk is always constant. On the other hand, in the CAV (Constant Angular Velocity) system, the rotation or revolution is controlled by maintaining the angular velocity to be constant when the optical disk is rotated.

The CLV system has the following features. (1) The signal processing circuit can be extremely simplified, because the data transfer rate is always constant during the recording and the reproduction. (2) The temperature hysteresis of the recording layer can be made constant when the recording and the erasing are performed, because the relative velocity between the laser beam and the optical disk can be always made constant. Therefore, the load exerted on the information-recording medium is small. (3) When the laser beam is moved in the radial direction of the optical disk, it is necessary to newly control the number of revolutions of the motor depending on the radial position. Therefore, the access speed is greatly lowered.

The CAV system has the following features. (1) The signal processing circuit is large-sized, because the data transfer rate differs depending on the radial position during the recording and the reproduction. (2) The temperature hysteresis of the recording layer greatly depends on the radial position when the recording and the erasing are performed, and the optical disk is required to be specially designed and constructed, because the relative velocity between the laser beam and the optical disk differs depending on the radial position. (3) When the laser beam is moved in the radial direction of the optical disk, it is unnecessary to newly control the number of revolutions of the motor depending on the radial position. Therefore, it is possible to perform the high speed access.

The present inventors have revealed the fact that extremely satisfactory recording and reproduction characteristics can be realized even in the high speed recording in which the disk linear velocity exceeds 20 m/s as developed at present, by using the Bi—Ge—Te-based phase-change recording layer material as disclosed in the exemplary conventional technique.

However, the exemplary conventional technique does not sufficiently consider the problem to be caused when the CAV recording is performed. Therefore, a problem arises such that the quality of the reproduced signal reproduced from the recorded information is greatly deteriorated at the inner circumferential portion of the information-recording medium when the CAV recording is performed, depending on the composition of the Bi—Ge—Te-based phase-change recording layer material (Problem 1).

The present inventors have revealed the following problem. That is, when the Bi—Ge—Te-based phase-change recording material disclosed in the exemplary conventional technique is used, then the reproduced signal is greatly deteriorated, and especially the shape in the vicinity of the mark edge of the recording mark is deteriorated only at the inner circumferential portion depending on the composition thereof when the recording is performed multiple times, i.e., not less than 1,000 times. Further, the present inventors have revealed the following problem. That is, when the recording track is wobbled to record the address information and the synchronization information on the wobble, then the deterioration of the reproduced signal as the sum signal affects the wobble signal as the difference signal, and the deterioration of the wobble signal simultaneously occurs (Problem 2).

The present inventors have revealed the presence of the following relationship. That is, when the Bi—Ge—Te-based phase-change recording material disclosed in the exemplary conventional technique is used, the storage life differs in the long term storage between the recording mark (amorphous mark) recorded at the inner circumferential portion and the recording mark recorded at the outer circumferential portion depending on the composition thereof. If it is intended to improve the long term storage life of the recording mark at the outer circumferential portion, the storage life of the recording mark recorded at the inner circumferential portion is deteriorated. On the contrary, if it is intended to improve the long term storage life of the recording mark at the inner circumferential portion, the storage life of the recording mark recorded at the outer circumferential portion is deteriorated (Problem 3).

The present inventors have revealed the following fact. That is, when the Bi—Ge—Te-based phase-change recording material disclosed in the exemplary conventional technique is used, a phenomenon (so-called “cross-erase”) consequently occurs only at the inner circumferential portion depending on the composition thereof, in which a part of the mark recorded on the adjoining track is crystallized when the recording mark is recorded (Problem 4).

The compatibility or the interchangeability with respect to a variety of information-recording apparatuses is extremely important for the exchangeable information-recording medium such as the optical disk. As for the DVD-RAM medium, for example, the DVD-RAM drive, which is adapted to the ×2 speed recording (transfer rate: 22 Mbps) based on the CLV rotation control, has been already present in the market. Therefore, it is indispensable for the benefit of the consumer to guarantee the recording and the reproduction on the DVD-RAM medium for the CAV recording (22 to 55 Mbps) with the drive adapted to the ×2 speed CLV. It is of course extremely important to guarantee the recording and the reproduction with the drive adapted to CAV on the DVD-RAM medium adapted to CAV having been subjected to the recording with the drive adapted to the ×2 speed CLV (the performance required for the compatibility is named by the present inventors to be “cross speed performance”).

As a result of diligent investigations on the cross speed performance of the DVD-RAM medium adapted to CAV developed by the present inventors, the present inventors have revealed the fact that the following three problems arise depending on the composition of the recording layer material when information is recorded again by means of the CLV rotation control on the information-recording medium on which information has been recorded by means of the CAV rotation control, or when information is recorded again by means of the CAV rotation control on the information-recording medium on which information has been recorded by means of the CLV rotation control:

(1) Deterioration of the cross speed overwrite performance (Problem 5);

(2) Deterioration of the cross speed crosstalk performance (Problem 6); and

(3) Deterioration of the cross speed cross-erase (Problem 7).

The problems as described above result from the fact that the recording mark recorded at the high speed and the recording mark recorded at the relatively low speed are present in a mixed manner at the identical radius on the identical medium.

The recording and the reproduction can be performed in a wide linear velocity region ranging from the linear velocity at the innermost circumferential portion to the linear velocity at the outermost circumferential portion on the information-recording medium adapted to the CAV recording. Therefore, such an information-recording medium can be used in a variety of ways, for example, other than the use for the CAV recording, depending on the way of use of the consumer. For example, when such an information-recording medium is rotated so that the linear velocity equivalent to the linear velocity at the outer circumferential portion is also obtained at the inner circumferential portion, the average transfer rate with respect to the medium is extremely improved, although the access speed becomes slow. It is also conceived that the CAV recording is performed again on an identical information-recording medium. Also in such a case, the recording mark subjected to the high speed recording equivalent to that for the outer circumferential portion and the recording mark subjected to the low speed recording equivalent to that for the inner circumferential portion are present in a mixed manner at the inner circumferential portion. Therefore, the cross speed performance as described above is important. Further, the following method of use (so-called “partial CAV system”) may be also conceived, in which both of the merits of the CAV recording and the CLV recording may be incorporated, depending on the way of use. That is, the medium is rotated in accordance with the CAV system in which the rotation is effected at a high speed (for example, about twice the ordinary number of revolutions of the CAV recording) as compared with ordinary cases at the inner circumferential portion at which the number of revolutions is changed relatively greatly by the radial movement of the optical head, while the high speed CLV recording and reproduction are performed at the outer circumferential portion. Also in this case, when the recording is performed again in accordance with the different types of rotation control on the identical medium, the marks, which have been recorded at various linear velocities, are present. Therefore, the cross speed performance as described above is extremely important.

When it is intended to respond to the recording at a plurality of linear velocities in the CLV recording as well, it has been revealed that the problems referred to as Problems 5, 6, and 7 occur in some cases in the same manner as in the CAV recording when it is intended to respond to the ×2 speed recording (transfer rate: 22 Mbps) and the ×3 speed recording (transfer rate: 33 Mbps), as exemplified, for example, by the DVD-RAM medium. Further, the following problem arises in the case of the Ge—Sn—Sb—Te system. That is, when Sn is increased in place of Ge, then the amount of change of the refractive index is decreased, and it is difficult for the reflectance and the modulation degree to satisfy the specifications of DVD-RAM. Further, in the case of the ×5 speed recording, the following problem arises. That is, the conventional Ge—Sb—Te-based phase-change recording material cannot realize the ×5 speed unless at least one nucleus-generating layer is added, which results in the factor to increase the cost of the disk and which results in the fact that the disk structure is complicated (Problem 8).

Therefore, an object of the present invention is to provide an information-recording medium which makes it possible to solve all of the following problems having been explained in detail above:

Problem 1: deterioration of the signal at the innermost circumferential portion during the CAV recording;

Problem 2: deterioration of the multiple times rewriting performance at the innermost circumferential portion during the CAV recording;

Problem 3: deterioration of the storage life at the innermost circumferential portion and the outermost circumferential portion during the CAV recording;

Problem 4: deterioration of the cross-erase performance at the innermost circumferential portion during the CAV recording;

Problem 5: deterioration of the cross speed overwrite performance;

Problem 6: deterioration of the cross speed crosstalk performance;

Problem 7: deterioration of the cross speed cross-erase performance; and

Problem 8: increase of the number of layers in order to secure the cross speed performance (addition of the nucleus-generating layer).

Next, an explanation will be made about problems caused when information is recorded on the phase-change optical disk by using a blue laser beam having a wavelength of 405 nm.

In general, it is known that the spot diameter of the laser beam is proportional to λ/NA provided that λ represents the laser wavelength and NA represents the numerical aperture of the lens. The laser spot diameter, which is obtained when the semiconductor laser having the wavelength of 405 nm and an objective lens having a numerical aperture NA of 0.85 are used, is about a half of the laser spot diameter which is obtained when the semiconductor laser having the wavelength of 650 nm and the objective lens having the numerical aperture NA of 0.60 are used as used for DVD. Even when the semiconductor laser having the wavelength of 405 nm and an objective lens having a numerical aperture NA of 0.65 are used, the laser spot diameter is small, i.e., about 60% of the laser spot diameter obtained in the case of DVD. Therefore, when the overwrite is tried at an identical linear velocity, the erasing residue, which is caused by the overwrite of previously recorded information, tends to appear, because the period of time of the passage over a certain point on the recording track is also shortened.

In general, when the wavelength is shortened, the difference in optical constant (Δn, Δk) between the crystalline portion and the amorphous portion of the recording material is decreased. Therefore, the difference in reflectance (contrast) between the recorded portion and the non-recorded portion is decreased, and the amplitude of the reproduced signal is decreased.

The energy intensity at the center of the beam of the blue laser is higher than that of the red laser, corresponding to an amount of the focusing of the beam of the blue laser. Therefore, the damage, which is exerted on the recording layer by the multiple times rewriting, is increased. Further, information is more deteriorated by the multiple times reproduction as well.

The present inventors have investigated, for example, the Ge—Sb—Te-based material, the Ge—Sn—Sb—Te-based material, the Ag—In—Sb—Te-based material, the Bi—Ge—Te-based material, the Bi—Ge—Sb—Te-based material, and the Bi—Ge—Se—Te-based material as exemplified in the exemplary conventional techniques, and developed the material which results in a small amount of erasing residue caused by the overwrite even when the blue laser is used. However, in the case of the materials of the exemplary conventional techniques, there is no consideration about the problem in which the reproduced signal amplitude is decreased as described above and the problem in which the damage is caused by the multiple times rewriting or reproduction. Therefore, other problems still remain, for example, such that the signal is greatly deteriorated by the rewriting performed not less than 1,000 times and the signal amplitude is decreased. Further, a problem also still remains such that the cross-erase is conspicuous, in which a part of the mark recorded on the adjoining track is crystallized when the track pitch is narrowed or when both of the groove and the land between the grooves provided on the substrate are used as the recording tracks. When the problem of cross-erase arises, then it is impossible to narrow the track pitch, and it is impossible to sufficiently exhibit the effect obtained by decreasing the beam diameter by using the blue laser.

### SUMMARY OF THE INVENTION

Therefore, an object of the present invention is to provide an information-recording medium which makes it possible to solve all of the problems involved in the conventional recording layer materials having been explained in detail above.

In order to explain the means for solving the problems, at first, the eight problems described above will be further sorted out and explained in detail. As a result of experiments and analysis of experimental data performed by the present inventors, it has been revealed that the eight problems are caused by roughly classified four causes. That is, Problems 1, 4, 5, 6, 7, and 8 were caused by a common cause (Cause 1: recrystallization of the recording mark during the low linear velocity recording). Problem 2 was caused by another cause (Cause 2: segregation of the recording layer material due to the repeated execution of the low linear velocity recording). Problem 3 was caused by two causes (Cause 3: time-dependent change of the amorphous state of the recording mark, Cause 4: crystallization of the recording mark due to the long term storage). The relationships between Causes 1, 2, 3, and 4 and the respective problems will be explained in detail below, and then the means for solving the problems will be described.

Cause 1: Recrystallization of Recording Mark During Low Linear Velocity Recording

The recrystallization resides in the following phenomenon (shrink). That is, the crystal growth takes place from the outer edge of the melted area during the cooling process immediately after heating the recording layer material to a temperature of not less than the melting point by using the laser beam, and the size of the recording mark is consequently decreased. This phenomenon is dissolved by lowering the crystallization speed of the recording layer material. Therefore, this phenomenon is not considered as a problem in the case of the phase-change optical disk based on the CLV recording system practically used at present. However, when the CAV recording is performed, it is impossible to erase the recording mark at the outer circumferential portion when the crystallization speed of the recording layer material is lowered to such an extent that the recrystallization can be suppressed at the inner circumferential portion. As a result, the problem arises such that the quality of the reproduced signal is deteriorated.

When the shrink of the recording mark caused by the recrystallization is too large, the deterioration of the reproduced signal occurs as indicated by Problem 1. This results from the fact that the amplitude of the reproduced signal is decreased due to the shrink of the recording mark and that the noise is generated by the reflectance dispersion resulting from the difference between the crystal size of the recrystallized portion and the crystal grain size of the normally crystallized portion. It is also possible to enhance the laser power and effect the melting over a wider area in order to improve the reproduced signal amplitude. However, in this case, the problem, in which the recording mark on the adjoining track is erased, arises (Problem 4). The cooling speed of the melted area is quickened after melting the recording layer during the high linear velocity recording, and hence the recrystallization is not caused. Therefore, this problem does not arise. However, when the low velocity recording is performed on the adjoining track, the problem of the cross-erase is more serious, because the size of the recorded mark is large (Problem 7). When the low velocity recording is performed on a certain track, and the high velocity recording is performed on a track adjacent thereto, then the width of the recording mark recorded on the adjacent track is increased. Therefore, the leakage (crosstalk) of the reproduced signal from the adjacent track is apt to occur (Problem 6). When the high velocity recording is performed over the recording mark having been subjected to the low velocity recording, the reproduced signal is doubly deteriorated by the insufficient erasing of the recording mark caused by the high velocity recording and the noise due to the low velocity recording having been subjected to the recording. Therefore, the overwrite performance is greatly deteriorated (Problem 5). As described above, Problems 1, 4, 5, 6, and 7 are caused by the recrystallization during the low velocity recording. In the conventional technique, in order to solve Problems 1, 4, 5, 6, and 7, it is necessary that the nucleus-generating layer is added to the conventional Ge—Sb—Te-based phase-change recording material. The increase of the number of layers is disadvantageous in view of the cost (Problem 8).

Cause 2: Segregation of Recording Layer Material Due to Repeated Execution of Low Linear Velocity Recording

The present inventors have revealed the following phenomenon when the Bi—Ge—Te-based material is used for the DVD-RAM medium adapted to the CAV recording. That is, the deterioration of the reproduced signal is not caused at all even when the recording is repeatedly performed 100,000 times when the recording at the high velocity (transfer rate: 55 Mbps, linear velocity: 20.5 m/s) equivalent to the linear velocity at the outermost circumferential portion is performed. However, the reproduced signal is greatly deteriorated when the recording is repeatedly performed only about 1,000 times when the recording at the low velocity (transfer rate: 22 Mbps, linear velocity: 8.2 m/s) equivalent to the linear velocity at the innermost circumference is performed. The difference in repeated rewriting durability is of such a magnitude that no explanation can be made on the basis of only the difference in radiation time of the laser beam between the low velocity recording and the high velocity recording. As a result of detailed investigations about this phenomenon, the following fact has been revealed. That is, when the recording is performed at the recording velocity equivalent to the linear velocity at the innermost circumferential portion, the amount of recrystallization is gradually increased as the recording is repeatedly performed. For this reason, the shape of the edge of the recording mark is changed. This is considered to result from the fact that the crystallization speed in the recrystallization area is gradually increased due to the repeated recording. The degree of harmful influence exerted on the signal quality by the deterioration of the recording film is large in the mark edge recording as compared with the mark position recording. Therefore, the deterioration of the reproduced signal is especially increased.

Cause 3: Time-Dependent Change of Amorphous State of Recording Mark

When the high velocity recording equivalent to that for the outermost circumferential portion is performed, a phenomenon arises, in which the crystallization speed of the recording mark is gradually lowered in accordance with the long term storage, and the crystallization is hardly caused in the worst case. The cause of this phenomenon is considered such that the amorphous state of the recording mark is gradually changed due to the long term storage, and the amorphous state is changed to another more stable amorphous state. The reason, why a plurality of amorphous states exist as described above, has not been elucidated. However, probably, it is considered that a plurality of crystalline states exist in the recording film before the melting, the crystalline states are reflected after the melting as well, and a variety of amorphous states are present in a dispersed manner. As a result, the crystallization speed of the amorphous matter may be changed in a time-dependent manner, and the crystallization speed may be gradually lowered.

Cause 4: Crystallization of Recording Mark Due to Long Term Storage

In contrast to the phenomenon described for Cause 3, when the low velocity recording equivalent to that for the innermost circumferential portion is performed, a problem arises such that the recording mark is gradually crystallized due to the long term storage. It is considered that the cause of this problem results from the fact that the crystallization temperature of the recording layer material is too low, and the activation energy is small when the change is made from the amorphous to the crystal. Further, the cooling speed for the melted area is small during the low velocity recording. Therefore, it is considered that crystal nuclei are generated in the cooling process.

As explained in detail above, Problems 1, 2, 4, 5, 6, 7, and 8 are caused by Causes 1 and 2. Both of Causes 1 and 2 can be solved by suppressing the recrystallization. In order to solve Problem 3, it is important that the plurality of amorphous states do not exist in the recording mark, and it is important that the crystallization temperature of the recording layer material is high and the activation energy is large when the amorphous matter is crystallized.

As also described in Japanese Patent Application Laid-open No. 62-209741, the practical composition range of the Bi—Ge—Te-based phase-change material exists in an area defined by connecting GeTe and Bi₂Te₃ in the triangular composition diagram having the apexes corresponding to Bi, Ge, and Te. However, the present inventors have experimentally revealed the fact that an area, in which Ge is excessively added as compared with those existing on the line obtained by connecting GeTe and Bi₂Te₃ (Bi₄₀Te₆₀), is suitable for the high speed recording, especially for the CAV recording.

The hypothesis presented by the present inventors in order to explain the mechanism is as follows. That is, within the range having been elucidated until the present, the Bi—Ge—Te-based material includes compounds of GeTe, Bi₂Te₃, Bi₂Ge₃Te₆, Bi₂GeTe₄, and Bi₄GeTe₇. When the recrystallization occurs immediately after the melting of the recording layer, the recrystallization is considered to occur from the outer edge of the melted area in an order from those having high melting points of the foregoing compounds and Bi, Ge, and Te, although any difference exists depending on the compositions. These substances are listed below in an order from those having higher melting points.

Ge: about 937° C.;

GeTe: about 725° C.;

Bi₂Ge₃Te₆: about 650° C.;

Bi₂Te₃: about 590° C.;

Bi₂GeTe₄: about 584° C.;

Bi₄GeTe₇: about 564° C.;

Te: about 450° C.;

Bi: about 271° C.

It is considered that Ge tends to be segregated at the outer edge of the melted area by excessively adding Ge as compared with those existing on the line for connecting GeTe and Bi₂Te₃ in the triangular composition diagram having the apexes of Bi, Ge, and Te, because the melting point of Ge is highest as described above. If Ge exists in an excessive amount at the outer edge of the melted area, then the crystallization speed is slow at the outer edge of the melted area, and the recrystallization from the outer edge can be consequently suppressed. Accordingly, the recrystallization is not caused even in the case of the low velocity recording. As a result, it is possible to solve Problems 1, 2, 4, 5, 6, 7, and 8. Simultaneously, the crystallization speed is high in the vicinity of the track center. Therefore, satisfactory erasing performance is also obtained during the high velocity recording. However, when the number of excessive Ge atoms is too large, the crystallization speed is consequently lowered. It is impossible to perform the high velocity recording equivalent to that at the recording velocity at the outer circumferential portion. Therefore, it is important to add an appropriately excessive amount of Ge.

In order to solve Problem 3, it is important that the plurality of amorphous states do not exist in the recording mark. Further, it is important that the crystallization temperature of the recording layer material is high, and the activation energy is large when the amorphous matter is crystallized. The present inventors have revealed the fact that the condition as described above is satisfied in the vicinity of Ge₅₀Te₅₀ on the triangular composition diagram having the apexes of Bi, Ge, and Te. One of the causes thereof is the fact that the crystallization temperature of GeTe is high, i.e., about 200° C. as described in the exemplary conventional technique as well and the crystallization temperature is lowered as the composition approaches Bi₂Te₃. The present inventors have experimentally revealed the fact that the amorphous state is hardly changed and satisfactory erasing characteristics are obtained even after the long term storage in the vicinity of Ge₅₀Te₅₀. However, if the amount of GeTe is too large, then the crystallization speed is lowered, and it is impossible to perform the recording at the high velocity equivalent to the recording velocity at the outer circumferential portion. If the amount of Bi₂Te₃ is too large, the storage life is deteriorated, because the crystallization temperature is lowered. Therefore, the optimum composition exists in the vicinity of Ge₅₀T₅₀, and the composition is preferably obtained by adding an appropriate amount of Bi₂Te₃. Further, the composition is in an area in which an excessive amount of Ge exists.

Therefore, in order to solve the problems described above, it is enough to use any one of the following information-recording media.

(1) An information-recording medium comprising a substrate and a recording layer which is rewritable multiple times and on which information is recorded in accordance with a phase-change reaction caused by being irradiated with a laser beam, for recording the information by performing relative scanning across the laser beam, wherein the recording layer has such a composition that a material for the recording layer contains Bi, Ge, and Te, and composition ratios thereof are within a range surrounded by the following respective points on a triangular composition diagram having apexes corresponding to Bi, Ge, and Te:

B3 (Bi₃, Ge₄₆, Te₅₁);

C3 (Bi₄, Ge₄₆, Te₅₀);

D3 (Bi₅, Ge₄₆, Te₄₉);

D5 (Bi₁₀, Ge₄₂, Te₄₈);

C5 (Bi₁₀, Ge₄₁, Te₄₉);

B5 (Bi₇, Ge₄₁, Te₅₂).

(2) When the composition ratios of Bi, Ge, and Te contained in the recording layer are within a range surrounded by the following respective points on the triangular composition diagram having the apexes corresponding to Bi, Ge, and Te, the reliability on the multiple times rewriting is remarkably improved, because the deterioration of the reproduced signal is extremely decreased even when the recording of information is repeated about 100,000 times:

F3 (Bi_{3.5}, Ge₄₆, Te_{50.5})

C3 (Bi₄, Ge₄₆, Te₅₀);

D3 (Bi₅, Ge₄₆, Te₄₉);

D5 (Bi₁₀, Ge₄₂, Te₄₈);

C5 (Bi₁₀, Ge₄₁, Te₄₉);

F5 (Bi_{7.5}, Ge₄₁, Te_{51.5})

(3) An information-recording medium comprising a substrate and a recording layer which is rewritable multiple times and on which information is recorded in accordance with phase-change caused by being irradiated with a laser beam, for recording the information by performing relative scanning across the laser beam at a certain linear velocity, wherein the recording layer has such a composition that a material for the recording layer contains Bi, Ge, and Te, and composition ratios thereof are within a range surrounded by the following respective points on a triangular composition diagram having apexes corresponding to Bi, Ge, and Te, and the composition ratios of Bi, Ge, and Te of the recording layer material satisfy ((GeTe)ₓ(Bi₂Te₃)₁₋ₓ)_{1-y}Ge_{y} provided that 0<x<1 and 0<y<1 are satisfied:

B2 (Bi₂, Ge₄₇, Te₅₁);

C2 (Bi₃, Ge₄₇, Te₅₀);

D2 (Bi₄, Ge₄₇, Te₄₉);

D6 (Bi₁₆, Ge₃₇, Te₄₇);

C8 (Bi₃₀, Ge₂₂, Te₄₈);

B7 (Bi₁₉, Ge₂₆, Te₅₅).

(4) An information-recording medium comprising a substrate and a recording layer which is rewritable multiple times and on which information is recorded in accordance with phase-change caused by being irradiated with a laser beam, for recording the information by performing relative scanning across the laser beam at a certain linear velocity, wherein the recording layer has such a composition that a material for the recording layer contains Bi, Ge, and Te, and composition ratios thereof are within a range surrounded by the following respective points on a triangular composition diagram having apexes corresponding to Bi, Ge, and Te, and the recording layer has a film thickness of not more than 15 nm:

B2 (Bi₂, Ge₄₇, Te₅₁);

C2 (Bi₃, Ge₄₇, Te₅₀);

D2 (Bi₄, Ge₄₇, Te₄₉);

D6 (Bi₁₆, Ge₃₇, Te₄₇);

C8 (Bi₃₀, Ge₂₂, Te₄₈);

B7 (Bi₁₉, Ge₂₆, Te₅₅).

(5) An information-recording medium comprising a substrate and a recording layer which is rewritable multiple times and on which information is recorded in accordance with phase-change caused by being irradiated with a laser beam, for recording the information by performing relative scanning across the laser beam at a certain linear velocity, wherein the recording layer has such a composition that a material for the recording layer contains Bi, Ge, and Te, and composition ratios thereof are within a range surrounded by the following respective points on a triangular composition diagram having apexes corresponding to Bi, Ge, and Te, and a thermostable layer is adhered to the recording layer:

B2 (Bi₂, Ge₄₇, Te₅₁);

C2 (Bi₃, Ge₄₇, Te₅₀);

D2 (Bi₄, Ge₄₇, Te₄₉);

D6 (Bi₁₆, Ge₃₇, Te₄₇);

C8 (Bi₃₀, Ge₂₂, Te₄₈);

B7 (Bi₁₉, Ge₂₆, Te₅₅).

(6) It is preferable that the thermostable layer has a melting point of not less than 650° C., in view of the fact that the rewriting durability is improved.

(7) Any one of oxide, carbide, and nitride having a melting point of not less than 650° C. can be used for the thermostable layer.

(8) An information-recording medium comprising a substrate and a recording layer which is rewritable multiple times and on which information is recorded in accordance with phase-change caused by being irradiated with a laser beam, for recording the information by performing relative scanning across the laser beam at a certain linear velocity, wherein the recording layer has such a composition that a material for the recording layer contains Bi, Ge, and Te, and composition ratios thereof are within a range surrounded by the following respective points on a triangular composition diagram having apexes corresponding to Bi, Ge, and Te, and an absorptance control layer is formed on a side opposite to a side of the recording layer on which the laser beam comes thereinto:

B2 (Bi₂, Ge₄₇, Te₅₁);

C2 (Bi₃, Ge₄₇, Te₅₀);

D2 (Bi₄, Ge₄₇, Te₄₉);

D6 (Bi₁₆, Ge₃₇, Te₄₇);

C8 (Bi₃₀, Ge₂₂, Te₄₈);

B7 (Bi₁₉, Ge₂₆, Te₅₅).

(9) When a material, in which n, k of complex refractive index of the absorptance control layer satisfy ranges of 1.4<n<4.5 and −3.5<k<−0.5, is used, it is possible to further increase a ratio Ac/Aa between an absorptance Aa of an amorphous portion of the recording layer and an absorptance Ac of a crystalline portion, which is preferred.

(10) A mixture of a metal and any one of metal oxide, metal sulfide, and metal nitride can be used for the absorptance control layer.

(11) An information-recording medium comprising a substrate and a recording layer which is rewritable multiple times and on which information is recorded in accordance with phase-change caused by being irradiated with a laser beam, for recording the information by performing relative scanning across the laser beam at a certain linear velocity, wherein the recording layer has such a composition that a material for the recording layer contains Bi, Ge, and Te, and composition ratios thereof are within a range surrounded by the following respective points on a triangular composition diagram having apexes corresponding to Bi, Ge, and Te, and a heat-diffusing layer is formed on a side opposite to a side of the recording layer on which the laser beam comes thereinto:

B2 (Bi₂, Ge₄₇, Te₅₁);

C2 (Bi₃, Ge₄₇, Te₅₀);

D2 (Bi₄, Ge₄₇, Te₄₉);

D6 (Bi₁₆, Ge₃₇, Te₄₇);

C8 (Bi₃₀, Ge₂₂, Te₄₈);

B7 (Bi₁₉, Ge₂₆, Te₅₅).

(12) A material, which contains a main component of any one of Al, Cu, Ag, Au, Pt, and Pd, is preferred for the heat-diffusing layer, in view of the fact that the reflectance is high, and the heat is promptly diffused.

(13) When at least a protective layer is further provided between the recording layer and the heat-diffusing layer, and the protective layer has a film thickness of not less than 25 nm and not more than 45 nm, then the cross-erase is further decreased, and the obtained contrast is satisfactory, which is preferred.

(14) When at least a protective layer and an absorptance control layer are further provided between the recording layer and the heat-diffusing layer, and a distance between the recording layer and the heat-diffusing layer is not less than 35 nm and not more than 125 nm, then the overwrite characteristics are improved, and the effect to reduce the cross-erase is remarkable, which is preferred.

(15) As having been explained above, the CAV recording has such a user merit that the high speed access can be performed. However, the realization thereof is hindered by many problems (Problems 1 to 8), which has been extremely difficult. The present inventors have found out the fact that the CAV recording can be realized by an information-recording medium comprising a substrate and a recording layer which is rewritable multiple times and on which information is recorded in accordance with phase-change caused by being irradiated with a laser beam, for recording the information by performing relative scanning across the laser beam, wherein the information-recording medium has a disk-shaped configuration, a relationship between a recording linear velocity V1 at a radius R1 and a recording linear velocity V2 at a position R2 disposed outside R1 satisfies V2/V1≧R2/R1, and the recording layer has such a composition that a material for the recording layer contains Bi, Ge, and Te, and composition ratios thereof are within a range surrounded by the following respective points on a triangular composition diagram having apexes corresponding to Bi, Ge, and Te:

B2 (Bi₂, Ge₄₇, Te₅₁);

C2 (Bi₃, Ge₄₇, Te₅₀);

D2 (Bi₄, Ge₄₇, Te₄₉);

D6 (Bi₁₆, Ge₃₇, Te₄₇);

C8 (Bi₃₀, Ge₂₂, Te₄₈);

B7 (Bi₁₉, Ge₂₆, Te₅₅).

(16) In particular, the present inventors have found out the fact that the CAV recording can be preferably realized with the medium which satisfies R2/R1≧1.5 and which is provided with the recording layer having the composition within the range surrounded by B2, C2, D2, D6, C8, and B7 as described above.

(17) Further, the present inventors have found out the fact that the CAV recording can be also preferably realized with the medium which satisfies R2/R1≧2.4 and which is provided with the recording layer having the composition within the range surrounded by B2, C2, D2, D6, C8, and B7 as described above.

(18) When 8.14 m/s≦V1≦8.61 m/s is satisfied in the item (16) or (17) described above, the CAV recording can be realized especially preferably by providing the recording layer having the composition within the range surrounded by B2, C2, D2, D6, C8, and B7 as described above.

(19) When the information-recording medium as defined in any one of the items (15) to (18) is provided with the recording layer having such a composition that the composition ratios of Bi, Ge, and Te are within a range surrounded by the following respective points on the triangular composition diagram having the apexes corresponding to Bi, Ge, and Te, the reliability on the multiple times rewriting is remarkably improved, because the deterioration of the reproduced signal is extremely reduced even when the recording of information is repeated about 100,000 times:

F2 (Bi_{2.5}, Ge₄₇, Te_{50.5});

C2 (Bi₃, Ge₄₇, Te₅₀);

D2 (Bi₄, Ge₄₇, Te₄₉);

D6 (Bi₁₆, Ge₃₇, Te₄₇);

C8 (Bi₃₀, Ge₂₂, Te₄₈);

F7 (Bi₁₉, Ge₂₇, Te₅₄).

(20) It is an extremely effective method for realizing the large capacity to narrow the track pitch. However, the cross-erase tends to appear extremely frequently. The present inventors have found out the fact that the cross-erase can be greatly reduced by providing a recording layer having such a composition that a material for the recording layer contains Bi, Ge, and Te, and composition ratios thereof are within a range surrounded by the following respective points on a triangular composition diagram having apexes corresponding to Bi, Ge, and Te, even when a track pitch TP is a narrow track pitch of not more than 0.6×(λ/NA) provided that λ represents a wavelength of a laser beam and NA represents a numerical aperture of an objective lens for collecting the laser beam:

B2 (Bi₂, Ge₄₇, Te₅₁);

C2 (Bi₃, Ge₄₇, Te₅₀);

D2 (Bi₄, Ge₄₇, Te₄₉);

D6 (Bi₁₆, Ge₃₇, Te₄₇);

C8 (Bi₃₀, Ge₂₂, Te₄₈);

B7 (Bi₁₉, Ge₂₆, Te₅₅).

(21) Further, especially satisfactory characteristics are obtained by providing the recording layer having the composition within the range surrounded by B2, C2, D2, D6, C8, and B7 when λ is within a range of 640 nm≦λ≦665 nm, NA is within a range of 0.6≦NA≦0.65, and TP≦0.618 μm is satisfied.

(22) A method, in which both of the groove and the land are used for the recording track, is extremely effective to realize the large capacity, because it is possible to narrow the track pitch as compared with a case in which any one of the groove and the land is used. However, the following problem arises due to the difference in thermal characteristic resulting from the difference in shape between the groove and the land. That is, the thermal hysteresis differs between the groove portion and the land portion of the recording layer, any difference appears in the recording/erasing characteristics, and the cross-erase appears. The present inventors have found out the fact that preferred characteristics are obtained by providing a recording layer having such a composition that a material for the recording layer contains Bi, Ge, and Te, and composition ratios thereof are within a range surrounded by the following respective points on a triangular composition diagram having apexes corresponding to Bi, Ge, and Te, even when both of the groove and the land are used for the recording track:

B2 (Bi₂, Ge₄₇, Te₅₁);

C2 (Bi₃, Ge₄₇, Te₅₀);

D2 (Bi₄, Ge₄₇, Te₄₉);

D6 (Bi₁₆, Ge₃₇, Te₄₇);

C8 (Bi₃₀, Ge₂₂, Te₄₈);

B7 (Bi₁₉, Ge₂₆, Te₅₅).

(23) A method for detecting the edge of the recording mark is extremely effective to realize the large capacity, because a large amount of information can be recorded with the mark having the same size as that used in a method for detecting the position of the recording mark. However, when the rewriting is repeated multiple times, especially the shape in the vicinity of the mark edge is greatly deteriorated. Therefore, a problem arises such that the reliability of information is conspicuously deteriorated. The present inventors have found out the fact that satisfactory characteristics are obtained by providing a recording layer having such a composition that a material for the recording layer contains Bi, Ge, and Te, and composition ratios thereof are within a range surrounded by the following respective points on a triangular composition diagram having apexes corresponding to Bi, Ge, and Te, even in the case of an information-recording medium on which information is read by detecting an edge of a recording mark:

B2 (Bi₂, Ge₄₇, Te₅₁);

C2 (Bi₃, Ge₄₇, Te₅₀);

D2 (Bi₄, Ge₄₇, Te₄₉);

D6 (Bi₁₆, Ge₃₇, Te₄₇);

C8 (Bi₃₀, Ge₂₂, Te₄₈);

B7 (Bi₁₉, Ge₂₆, Te₅₅).

(24) A method for wobbling the recording track is extremely effective to realize the efficient format and improve the reliability of information, because the address information and the synchronization information can be stored on the wobble. However, a problem arises such that the wobble facilitates the deterioration of the signal quality due to the multiple times rewriting, and the deterioration of the signal quality reversely exerts harmful influences on the wobble characteristics. This fact will be described in detail below.

The larger the wobble width is, the more the wobble signal quality is improved. However, if the wobble width is too large, any harmful influence is exerted on the recording signal. The wobble width is herein the maximum value of the distance between the virtual track center line obtained when no wobble exists and the center line of the wobbled track. When information is recorded on the track to which the wobble is applied, the recording is performed along with the virtual center line so that the recording head does not follow the wobble. Therefore, the central position in the direction perpendicular to the track of the recording mark is not necessarily coincident with the central position of the track at the concerning place. In particular, the present inventors have found out the following fact. That is, when the recording is performed on the tracks of both of the land and the groove, a phenomenon is caused such that the end of the recording mark extremely approaches the boundary position between the land and the groove, if the wobble width is too large. The thermal condition in the vicinity of the boundary is different from that at the center of the track. Therefore, when the conventional recording layer material is used, the deterioration of the recording layer tends to occur from such a portion when the rewiring is performed multiple times.

The present inventors have found out the fact that satisfactory characteristics are obtained by providing a recording layer having such a composition that a material for the recording layer contains Bi, Ge, and Te, and composition ratios thereof are within a range surrounded by the following respective points on a triangular composition diagram having apexes corresponding to Bi, Ge, and Te, even when the recording track is wobbled. In particular, even when the wobble width is given so that C/N of the wobble is not less than 30 dB, the deterioration of the wobble C/N and the quality of the recording signal after the rewriting multiple times were extremely small. The wobble C/N was determined by measuring the difference signal by using a spectrum analyzer with a band width of 10 kHz when the optical head is subjected to the scanning over the track.

B2 (Bi₂, Ge₄₇, Te₅₁);

C2 (Bi₃, Ge₄₇, Te₅₀);

D2 (Bi₄, Ge₄₇, Te₄₉);

D6 (Bi₁₆, Ge₃₇, Te₄₇);

C8 (Bi₃₀, Ge₂₂, Te₄₈);

B7 (Bi₁₉, Ge₂₆, Te₅₅).

(25) A method for using a laser having a wavelength of not less than 390 nm and not more than 420 nm is extremely effective to realize the large capacity, because the beam spot diameter is decreased. However, as compared with the laser having wavelengths of about 650 to 780 nm generally used for CD and DVD, the following problems arise. That is, (1) the energy intensity is high, and it is difficult to perform the rewriting multiple times. (2) The signal intensity is decreased because of the small difference in refractive index between the amorphous and the crystal. The present inventors have found out the fact that satisfactory characteristics are obtained by providing a recording layer having such a composition that a material for the recording layer contains Bi, Ge, and Te, and composition ratios thereof are within a range surrounded by the following respective points on a triangular composition diagram having apexes corresponding to Bi, Ge, and Te, even in the case of an information-recording medium for which a laser beam has a wavelength of not less than 390 nm and not more than 420 nm:

B2 (Bi₂, Ge₄₇, Te₅₁);

C2 (Bi₃, Ge₄₇, Te₅₀);

D2 (Bi₄, Ge₄₇, Te₄₉);

D6 (Bi₁₆, Ge₃₇, Te₄₇);

C8 (Bi₃₀, Ge₂₂, Te₄₈);

B7 (Bi₁₉, Ge₂₆, Te₅₅).

(26) Si, Sn, and Pb, which are homologous elements or elements belonging to the same family, may be used in place of Ge in the recording layer material to be used for the information-recording medium of the present invention. When an appropriate amount of Si, Sn, and/or Pb is added in place of Ge, the adaptable linear velocity range can be adjusted with ease. That is, a recording layer may be provided, which has such a composition that a composition of a material for the recording layer includes a base material of a Bi—Ge—Te-based recording layer within a range surrounded by the following respective points on a triangular composition diagram having apexes corresponding to Bi, Ge, and Te, wherein a part of Ge is substituted with at least one element of Si, Sn, and Pb:

B2 (Bi₂, Ge₄₇, Te₅₁);

C2 (Bi₃, Ge₄₇, Te₅₀);

D2 (Bi₄, Ge₄₇, Te₄₉);

D6 (Bi₁₆, Ge₃₇, Te₄₇);

C8 (Bi₃₀, Ge₂₂, Te₄₈);

B7 (Bi₁₉, Ge₂₆, Te₅₅).

(27) When B is added to the recording layer material to be used for the information-recording medium of the present invention, it is possible to obtain the information-recording medium in which the recrystallization is further suppressed and more excellent performance is exhibited. That is, there is provided an information-recording medium comprising a recording layer having such a composition that a composition of the recording layer material includes a base material of a Bi—Ge—Te-based recording layer within a range surrounded by the following respective points on a triangular composition diagram having apexes corresponding to Bi, Ge, and Te, and B is added:

B2 (Bi₂, Ge₄₇, Te₅₁);

C2 (Bi₃, Ge₄₇, Te₅₀);

D2 (Bi₄, Ge₄₇, Te₄₉);

D6 (Bi₁₆, Ge₃₇, Te₄₇);

C8 (Bi₃₀, Ge₂₂, Te₄₈);

B7 (Bi₁₉, Ge₂₆, Te₅₅).

(28) The medium as described above can be obtained by using a target for an information-recording material having a composition containing Bi, Ge, and Te, wherein composition ratios thereof are within a range surrounded by the following respective points on a triangular composition diagram having apexes corresponding to Bi, Ge, and Te:

B3 (Bi₃, Ge₄₆, Te₅₁);

C3 (Bi₄, Ge₄₆, Te₅₀);

D3 (Bi₅, Ge₄₆, Te₄₉);

D5 (Bi₁₀, Ge₄₂, Te₄₈);

C5 (Bi₁₀, Ge₄₁, Te₄₉);

B5 (Bi₇, Ge₄₁, Te₅₂).

(29) In the items (20) to (28) described above, when the recording layer, which has such a composition that composition ratios of Bi, Ge, and Te are within a range surrounded by the following respective points on a triangular composition diagram having apexes corresponding to Bi, Ge, and Te, is provided, the reliability on the multiple times rewriting is remarkably improved, because the deterioration of the reproduced signal is extremely reduced even when the recording of information is repeated about 100,000 times:

F2 (Bi_{2.5}, Ge₄₇, Te_{50.5})

C2 (Bi₃, Ge₄₇, Te₅₀);

D2 (Bi₄, Ge₄₇, Te₄₉);

D6 (Bi₁₆, Ge₃₇, Te₄₇);

C8 (Bi₃₀, Ge₂₂, Te₄₈);

F7 (Bi₁₉, Ge₂₇, Te₅₄).

When a nucleus-generating layer, which contains, for example, Bi₂Te₃, SnTe, and/or PbTe, is provided adjacent to the recording layer, the effect to suppress the recrystallization is further improved.

On condition that the recording layer material, which is used for the information-recording medium of the present invention, maintains the relationship within the range represented by the composition formulas described above, the effect of the present invention is not lost even when any impurity makes contamination, provided that the atomic % of the impurity is within 1%.

In the present invention, the information-recording medium is expressed as “phase-change optical disk” or simply “optical disk” in some cases. However, the present invention is applicable to any information-recording medium provided that the heat is generated by being irradiated with the energy beam, the atomic arrangement is changed by the heat, and the recording is performed thereby. Therefore, there is no special limitation to the shape of the information-recording medium. The present invention is also applicable to information-recording media such as optical cards other than disk-shaped information-recording media.

In this specification, the energy beam is expressed as “laser beam” or simply “laser light” or “light” in some cases. However, as described above, the present invention is effective provided that the energy beam is capable of generating the heat on the information-recording medium. Therefore, the effect of the present invention is not lost even when the energy beam such as the electron beam is used.

In the present invention, it is premised that the substrate is arranged on the light-incoming side or the side of the recording layer on which the light comes thereinto. However, the effect of the present invention is not lost even when the substrate is arranged on the side opposite to the light-incoming side or the side of the recording layer on which the light comes thereinto, and a protective material such as a protective sheet, which is thinner than the substrate, is arranged on the light-incoming side.

### BRIEF DESCRIPTION OF THE DRAWINGS

FIG. 1 illustrates a structure of an information-recording medium according to a first embodiment of the present invention.

FIG. 2 shows an information-recording and reproducing apparatus which is used in order to evaluate the information-recording medium of the present invention.

FIG. 3 shows results of evaluation performed in the first embodiment of the present invention.

FIG. 4 shows results of evaluation performed in the first embodiment of the present invention.

FIG. 5 shows results of evaluation performed in the first embodiment of the present invention.

FIG. 6 shows results of evaluation performed in the first embodiment of the present invention.

FIG. 7 shows results of evaluation performed in the first embodiment of the present invention.

FIG. 8 shows results of evaluation performed in the first embodiment of the present invention.

FIG. 9 shows a triangular composition diagram illustrating an optimum composition range in the first embodiment of the present invention.

FIG. 10 shows a triangular composition diagram illustrating an optimum composition range in the first embodiment of the present invention.

FIG. 11 shows results of evaluation performed in the first embodiment of the present invention.

FIG. 12 shows results of evaluation performed in the first embodiment of the present invention.

FIG. 13 shows results of evaluation performed in the first embodiment of the present invention.

FIG. 14 shows results of evaluation performed in the first embodiment of the present invention.

FIG. 15 shows a triangular composition diagram illustrating an optimum composition range in the first embodiment of the present invention.

FIG. 16 shows a triangular composition diagram illustrating an optimum composition range in the first embodiment of the present invention.

FIG. 17 illustrates a structure of an information-recording medium according to a second embodiment of the present invention.

### DESCRIPTION OF THE PREFERRED EMBODIMENTS

### First Embodiment

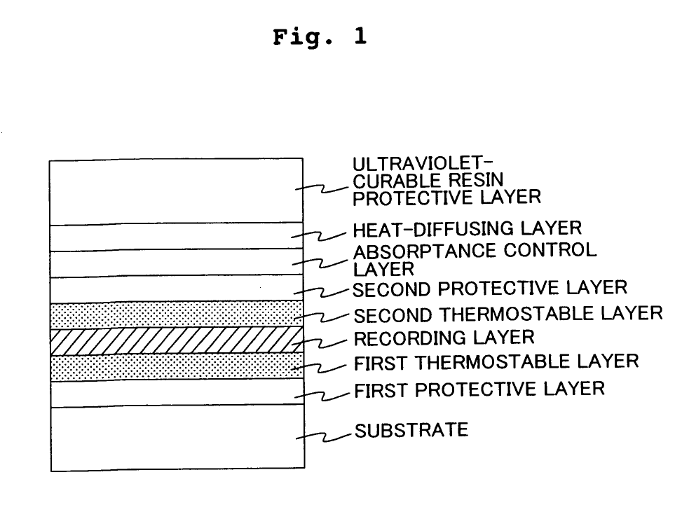

A first embodiment of the present invention will be described below with reference to FIGS. 1 to 16.

### Medium Structure

FIG. 1 shows a basic structure of an information-recording medium of the present invention. That is, the structure comprises a first protective layer, a first thermostable layer, a recording layer, a second thermostable layer, a second protective layer, an absorptance control layer, a heat-diffusing layer, and an ultraviolet-curable resin protective layer which are successively stacked on a substrate. A substrate having a thickness of 0.6 mm made of polycarbonate is used as the substrate. A groove shape and a prepit shape, which are of the same format as that for 4.7 GB DVD-RAM, are previously formed on the substrate. Specifically, the substrate, which was used in this embodiment, had lands and grooves which were formed at a track pitch of 0.615 μm within a range ranging from an inner circumferential position of 23.8 mm to an outer circumferential position of 58.6 mm of the recording area. Respective tracks were divided into sectors. Information corresponding to 43,152 channel bits was storable in one sector. Among them, 2,048 channel bits were used as a header signal area including address information or the like, and 32 channel bits were used as a mirror area in which neither land nor groove was formed. The recordable area of 41,072 channel bits included a gap area of 160+J channel bits, a guard area of 320+(16×K) channel bits, a VFO area of 560 channel bits, a PS area of 48 channel bits, a data area of 38,688 channel bits, a postamble area of 16 channel bits, a guard 2 area of 880-(16×K) channel bits, and a buffer area of 400-J channel bits. When the rewriting of information (overwrite) was performed in an identical sector, then J was randomly changed between 0 and 15, and K was randomly changed between 0 and 7. The data area of 38,688 channel bits included main data of 32,768 channel bits as well as data ID, error detection code, error correction code, parity code, SYNC code and so on. The track was wobbled at a cycle of 186 channel bits. The wobble C/N was 40 dB.

Films of (ZnS)₈₀(SiO₂)₂₀ of 135 nm as the first protective layer, Cr₂O₃ of 7 nm as the first thermostable layer, the recording layer of 8 nm as described later on, Cr₂O₃ of 5 nm as the second thermostable layer, (ZnS)₉₀(SiO₂)₂₀ of 33 nm as the second protective layer, Cr₉₀(Cr₂O₃)₁₀ of 40 nm as the absorptance control layer, and Al of 150 nm as the heat-diffusing layer were formed on the substrate by means of the sputtering process. Further, an ultraviolet-curable resin or UV resin was applied thereon, and a transparent substrate having a thickness of 0.6 mm was laminated while being irradiated with ultraviolet light. Thus, the information-recording medium used in the first embodiment as described below was obtained. The material for the recording layer will be explained in detail later on.

### Information-Recording/Reproducing Apparatus Used in this Embodiment

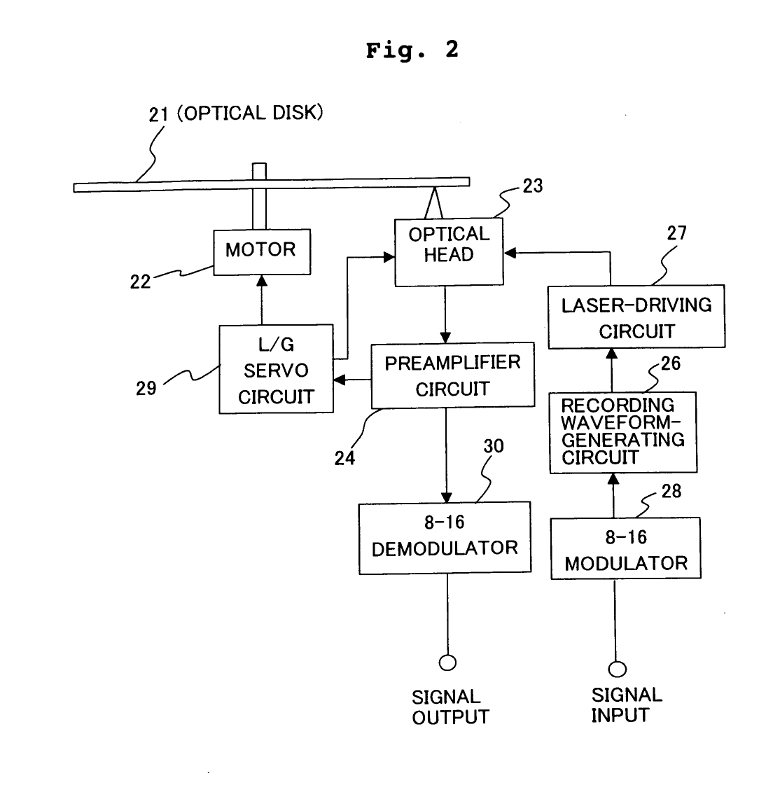

An explanation will be made below with reference to FIG. 2 about the operation of the apparatus as well as the recording and the reproduction of information on the information-recording medium of the present invention. The CAV system, in which the number of revolutions of the disk is changed for every zone for performing the recording and the reproduction, is adopted as the method for controlling the motor when the recording and the reproduction are performed. The linear velocity of the disk is 8.2 m/second at the innermost circumference (radius: 24 mm) and 20 m/second at the outermost circumference (radius: 58.5 mm). Basically, in the present invention, the term “inner circumferential portion” indicates a radius of about 24 mm, and the term “outer circumferential portion” indicates a radius of about 58.5 mm. For the convenience of the experiment, the information-recording medium is rotated at a recording linear velocity equivalent to that at the inner circumferential portion and a recording linear velocity equivalent to that at the outer circumferential portion by changing the number of revolutions at an intermediate circumferential portion (radius: 40 mm) to perform the experiment in some cases. However, it goes without saying that the effect of the present invention is not lost even when such an experiment is performed.

Next, the process of recording and reproduction will be described below. At first, the information, which is supplied from the outside of the recording apparatus, is transmitted to an 8-16 modulator 28 with 8 bits of one unit. When the information is recorded on the information-recording medium (hereinafter referred to as “optical disk”) 21, the mark edge system is used to perform the recording by using the modulation system, i.e., the so-called 8-16 modulation system in which 8-bits information is converted into 16-bits information. In this modulation system, the information having mark lengths of 3T to 14T corresponding to 8-bits information is recorded on the medium. The 8-16 modulator 28 shown in the drawing performs this modulation. T herein indicates the clock cycle during the recording of information. T was 17.1 ns at the innermost circumference, and it was 7 ns at the outermost circumference.

The digital signals of 3T to 14T, which have been converted by the 8-16 modulator 28, are transmitted to a recording waveform-generating circuit 26. A multi-pulse recording waveform is generated as follows. That is, a laser, which is at a low power level having a width of about T/2, is radiated between radiations of a laser at a high power level provided that the high power pulse has a width of about T/2, and a laser at an intermediate power level is radiated between a series of radiations of the high power pulses as described above. In this process, the high power level for forming the recording mark and the intermediate power level capable of crystallizing the recording mark were adjusted to have most appropriate values for every medium to be measured and for every radial position. In the recording waveform-generating circuit 26, the signals of 3T to 14T are alternately designated to “0” and “1” in a chronological order. In the case of “0”, the laser power at the intermediate power level is radiated. In the case of “1”, a series of high power pulse arrays including high power level pulses are radiated. During this process, the portion on the optical disk 21, which is irradiated with the laser beam at the intermediate power level, is changed to the crystal. The portion, which is irradiated with the laser beam of the series of high power pulse arrays including high power level pulses, is changed to the amorphous (mark portion). A multi-pulse waveform table, which is adapted to the system for changing the leading pulse width and the trailing pulse width of the multi-pulse waveform (adapted type recording waveform control) depending on the space lengths before and after the mark portion when the series of high power pulse arrays including the high power level are formed in order to form the mark portion, is prepared in the recording waveform-generating circuit 26. Accordingly, the multi-pulse recording waveform, which makes it possible to exclude the influence of the thermal interference between the marks generated between the marks to be as less as possible, is generated.

The recording waveform, which is generated by the recording waveform-generating circuit 26, is transferred to a laser-driving circuit 27. The laser-driving circuit 27 causes the light emission of a semiconductor laser contained in an optical head 23, on the basis of the recording waveform. The semiconductor laser having a light wavelength of 655 nm is used for the laser beam for recording information in the optical head 23 which is carried on the recording apparatus described above. The laser beam is focused onto the recording layer of the optical disk 21 by using an objective lens having a lens NA of 0.6, and the laser beam of the laser corresponding to the recording waveform is radiated to record the information.

In general, when the laser beam having the laser wavelength λ is collected by the lens having the lens numerical aperture NA, the spot diameter of the laser beam is about 0.9×λ/NA. Therefore, on the condition as described above, the spot diameter of the laser beam is about 0.98 micron. In this procedure, the laser beam was circularly polarized.

The recording apparatus described above is adapted to the system (so-called “land-groove recording system”) in which information is recorded on both of the groove and the land (area between the grooves). In the recording apparatus described above, it is possible to arbitrary select the tracking for the land and the groove by using an L/G servo circuit 29. The reproduction of recorded information was also performed with the optical head 23 described above. A laser beam is radiated onto the mark having been subjected to the recording, and reflected light beams are detected from the mark and the portion other than the mark to obtain a reproduced signal. The amplitude of the reproduced signal is amplified with a preamplifier circuit 24, followed by being transferred to an 8-16 demodulator 30. The 8-16 demodulator 30 performs conversion into 8-bits information for every 16 bits. In accordance with the operation as described above, the reproduction of the recorded mark is completed. When the recording is performed on the optical disk 21 under the condition as described above, then the mark length of the 3T mark as the shortest mark is about 0.42 μm, and the mark length of the 14T mark as the longest mark is about 1.96 μm.

When the jitter at the inner circumferential portion and the jitter at the outer circumferential portion were dealt with, then random pattern signals including 3T to 14T were recorded and reproduced, and reproduced signals were subjected to the processing of waveform equivalence, binary conversion, and PLL (Phase Locked Loop) to measure the jitter.

### Evaluation Criteria for Recording Layer Material

In order to evaluate the signal quality and the recording erasing performance at the inner circumferential portion and the outer circumferential portion, the jitters (jitters after recording the random signal ten times) were measured at the recording linear velocities corresponding to those at the inner circumferential portion and the outer circumferential portion. In order to test the rewriting life, the jitters were measured after 10,000 times rewriting at the recording linear velocities corresponding to those at the inner circumferential portion and the outer circumferential portion respectively to measure the amounts of increase from the jitters obtained after 10 times recording. Further, in order to evaluate the influence of the recrystallization in the recording mark recorded at the recording linear velocity corresponding to that at the inner circumferential portion, a single frequency signal of 11 T was recorded at the recording linear velocity corresponding to that at the inner circumferential portion and at the recording linear velocity corresponding to that at the outer circumferential portion to measure the inner/outer circumferential amplitude ratio (amplitude at inner circumferential portion/amplitude at outer circumferential portion). In this procedure, in order to exclude the influence exerted by the error of the laser power setting, the recording was performed assuming that the optimum power was 1.7-fold the recording start power. An acceleration test was performed in order to evaluate the storage life. Specifically, a random signal was recorded 10 times at the linear velocity corresponding to that at the inner circumferential portion on a measurement objective medium to measure the jitter beforehand. The difference from the amount of increase of jitter was measured after being left to stand for 20 hours in an oven heated to 90° C. (so-called archival reproduction jitter). Further, the jitter was measured beforehand after recording a random signal 10 times at the recording linear velocity corresponding to that at the outer circumferential portion on a different track simultaneously with the test described above. The overwrite was performed only once on the same track after being maintained for 20 hours at a temperature of 90° C. to measure the difference from the jitter obtained before the acceleration test (so-called archival overwrite jitter). In this embodiment, the land-groove recording is adopted for the information-recording medium. Therefore, in this procedure, the average value of those obtained by recording information on the land and groove is described. Target values for the respective performances are as follows.

Jitter: not more than 10%;

Rewriting life: not more than 2%;

Inner/outer circumferential amplitude ratio: not less than 0.8;

Storage life (inner circumference): not more than 2%;

Storage life (outer circumference): not more than 3%.

The target value of 10% of the jitter is large as compared with the standard value (not more than 9%). However, as explained above, no change is made for the structure other than the composition of the recording layer, because only the performance of the recording layer is compared for the information-recording medium to be used in this embodiment. Therefore, the increase of the jitter of at least not less than 1% occurs as compared with a case in which the medium is constructed in a suitable manner for each of the recording layers. Accordingly, the target value is intentionally raised. However, when the medium was optimally constructed for each of several recording layer compositions in which the jitter was not more than 10% in this test, the jitter was lowered to be not more than 9% for all of the media. Therefore, the target value described above is reasonable to judge the performance of the composition of the recording layer. As for the evaluation of the recrystallization amount, it was assumed that the inner/outer circumferential amplitude ratio was not less than 0.8. However, the recrystallization was sufficiently suppressed in the information-recording medium which had achieved the target values as described above. Therefore, the problems did not occur, including the deterioration of the cross-erase performance at the innermost circumferential portion, the deterioration of the cross speed overwrite performance, the deterioration of the cross speed crosstalk performance, and the deterioration of the cross speed cross-erase performance. On the other hand, the probability to cause any one of the foregoing problems was particularly increased in the information-recording medium which did not achieve the target values as described above. Therefore, the target values described above are reasonable.

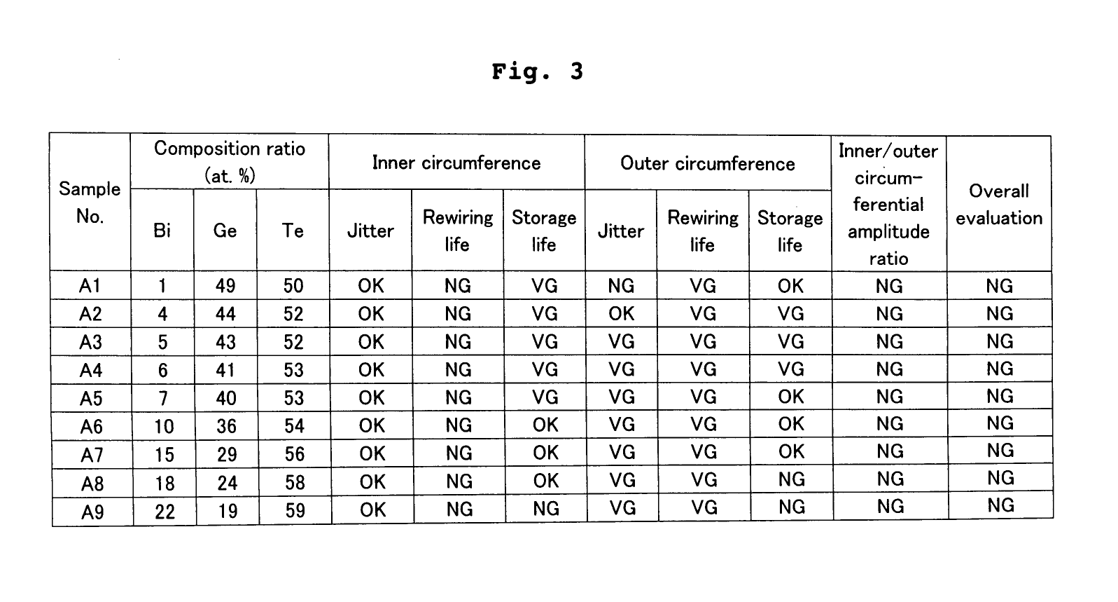

Results of the evaluation in this embodiment are expressed by VG (very good), OK, and NG (no good) in FIGS. 3 to 8 and 11 to 14, wherein the following judgment criteria are adopted.

Jitter

VG: not more than 9%, OK: not more than 10%, NG: more than 10%.

Rewriting Life

VG: not more than 1%, OK: not more than 2%, NG: more than 2%.

Inner/Outer Circumferential Amplitude Ratio

VG: not less than 0.9, OK: not less than 0.8, NG: less than 0.8.

Storage Life (Inner Circumference)

VG: not more than 1%, OK: not more than 2%, NG: more than 2%.

Storage Life (Outer Circumference)

VG: not more than 2%, OK: not more than 3%, NG: more than 3%.

Overall Evaluation

VG: all of the forgoing evaluation items were VG;

OK: NG was absent in the forgoing evaluation items, and at least one OK was present;

NG: NG was present in at least one of the foregoing evaluation items.

### Method for Forming Recording Layer

The co-sputtering with targets of Ge₅₀Te₅₀ and Bi₂Te₃ was performed in this embodiment in order to change the composition of the recording layer. In this embodiment, the investigation was also made for compositions added with excessive amounts of Ge and compositions added with excessive amounts of Te other than those existing on a line for connecting Ge₅₀Te₅₀ and Bi₂Te₃ in the triangular composition diagram having the apexes corresponding to Bi, Ge, and Te. In such cases, a sputtering target, which was obtained by sticking a small piece of Ge or a small piece of Te to the Bi₂Te₃ target, was used to perform the sputtering simultaneously with the sputtering target of Ge₅₀Te₅₀. Recording layer materials having desired compositions were obtained by adjusting the sputtering powers to be applied to the two types of the targets subjected to the co-sputtering respectively.

If the size of the Ge₅₀Te₅₀ target was the same as the size of the Bi₂Te₃ target, the sputtering rate of Bi₂Te₃ is too large. Therefore, it was difficult to correctly control the amount of addition of Bi₂Te₃ to the Ge₅₀Te₅₀ film. Accordingly, the size of the Bi₂Te₃ target was made smaller than the size of the Ge₅₀Te₅₀ target. Specifically, the Ge₅₀Te₅₀ target was disk-shaped to have a size of diameter of 5 inches, and the Bi₂Te₃ target was disk-shaped to have a size of diameter of 3 inches.

### Results of Evaluation of Recording Layer Materials

1. A Series

In A Series, information-recording media were prepared and evaluated, which contained recording layer materials added with excessive amounts of Te as compared with those existing on the line for connecting Ge₅₀Te₅₀ and Bi₂Te₃ (Bi₄₀Te₆₀) on the triangular composition diagram having the apexes corresponding to Bi, Ge, and Te. In this procedure, the recording layer material, which was subjected to the film formation with the sputtering target on the side of Bi—Te, had a composition of Bi₃₅Te₆₅. An explanation will be made below with reference to FIG. 3 about results of the evaluation of the recording layers having the respective compositions.

A1: The composition of the recording layer was Bi₁Ge₄₉Te₅₀. The rewriting life at the inner circumferential portion, the jitter at the outer circumferential portion, and the inner/outer circumferential amplitude ratio did not attain the target values. Therefore, the overall evaluation was NG.

A2: The composition of the recording layer was Bi₄Ge₄₄Te₅₂. The rewriting life at the inner circumferential portion and the inner/outer circumferential amplitude ratio did not attain the target values. Therefore, the overall evaluation was NG.

A3: The composition of the recording layer was Bi₅Ge₄₃Te₅₂. The rewriting life at the inner circumferential portion and the inner/outer circumferential amplitude ratio did not attain the target values. Therefore, the overall evaluation was NG.

A4: The composition of the recording layer was Bi₆Ge₄₁Te₅₃. The rewriting life at the inner circumferential portion and the inner/outer circumferential amplitude ratio did not attain the target values. Therefore, the overall evaluation was NG.

A5: The composition of the recording layer was Bi₇Ge₄₀Te₅₃. The rewriting life at the inner circumferential portion and the inner/outer circumferential amplitude ratio did not attain the target values. Therefore, the overall evaluation was NG.

A6: The composition of the recording layer was Bi₁₀Ge₃₆Te₅₄. The rewriting life at the inner circumferential portion and the inner/outer circumferential amplitude ratio did not attain the target values. Therefore, the overall evaluation was NG.

A7: The composition of the recording layer was Bi₁₅Ge₂₉Te₅₆. The rewriting life at the inner circumferential portion and the inner/outer circumferential amplitude ratio did not attain the target values. Therefore, the overall evaluation was NG.

A8: The composition of the recording layer was Bi₁₈Ge₂₄Te₅₈. The rewriting life at the inner circumferential portion, the rewriting life at the outer circumferential portion, and the inner/outer circumferential amplitude ratio did not attain the target values. Therefore, the overall evaluation was NG.

A9: The composition of the recording layer was Bi₂₂Ge₁₉Te₅₉. The rewriting life at the inner circumferential portion, the storage life at the inner circumferential portion, the storage life at the outer circumferential portion, and the inner/outer circumferential amplitude ratio did not attain the target values. Therefore, the overall evaluation was NG.

As described above, when the recording layer materials, which had the compositions obtained by adding the excessive amounts of Te to the recording layer materials existing on the line for connecting Ge₅₀Te₅₀ and Bi₂Te₃ on the triangular composition diagram having the apexes corresponding to Bi, Ge, and Te, were used, the inner/outer circumferential amplitude ratio and the rewriting life at the inner circumferential portion did not attain the target values in all of the information-recording media. It was revealed that the information-recording media were not practical for the CAV recording.

2. B Series

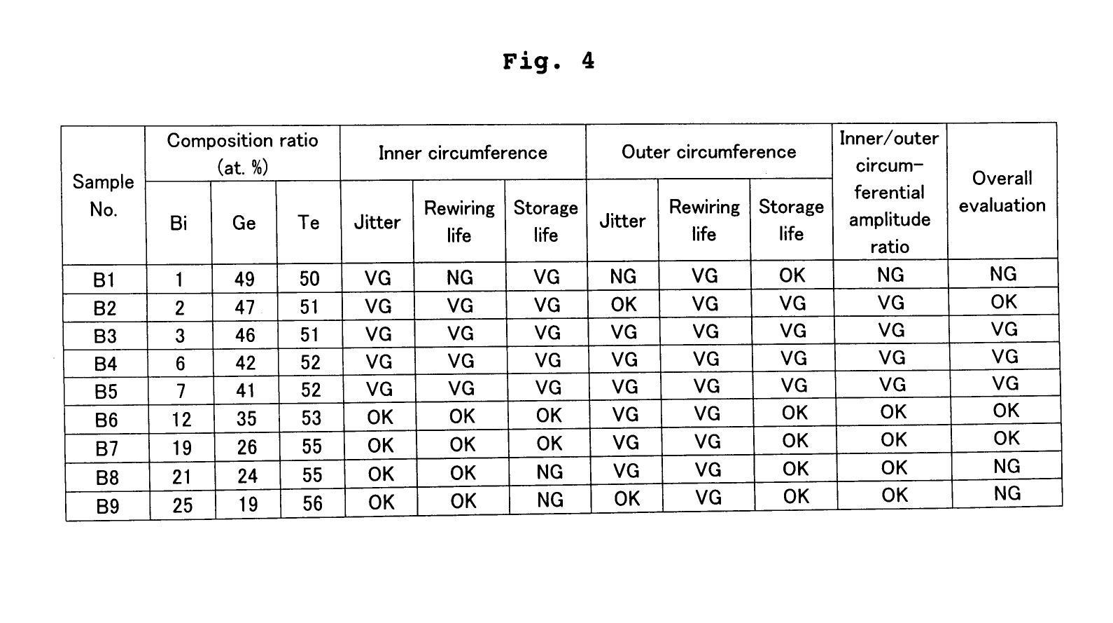

In B Series, information-recording media were prepared and evaluated, which contained recording layer materials existing on the line for connecting Ge₅₀Te₅₀ and Bi₂Te₃ on the triangular composition diagram having the apexes corresponding to Bi, Ge, and Te. In this procedure, the recording layer material, which was subjected to the film formation with the sputtering target on the side of Bi—Te, had a composition of Bi₄₀Te₆₀. An explanation will be made below with reference to FIG. 4 about results of the evaluation of the recording layers having the respective compositions.

B1: The composition of the recording layer was Bi₁Ge₄₉Te₅₀. The rewriting life at the inner circumferential portion, the jitter at the outer circumferential portion, and the inner/outer circumferential amplitude ratio did not attain the target values. Therefore, the overall evaluation was NG.

B2: The composition of the recording layer was Bi₂Ge₄₇Te₅₁. The target values were attained for all of the items. However, the evaluation was OK for the jitter at the outer circumferential portion. Therefore, the overall evaluation was OK.

B3: The composition of the recording layer was Bi₃Ge₄₆Te₅₁. The target values were sufficiently attained for all of the items. Therefore, the overall evaluation was VG.

B4: The composition of the recording layer was Bi₆Ge₄₂Te₅₂. The target values were sufficiently attained for all of the items. Therefore, the overall evaluation was VG.

B5: The composition of the recording layer was Bi₇Ge₄₁Te₅₂. The target values were sufficiently attained for all of the items. Therefore, the overall evaluation was VG.

B6: The composition of the recording layer was Bi₁₂Ge₃₅Te₅₃. The target values were attained for all of the items. However, the evaluation was OK for the jitter at the inner circumferential portion, the rewriting life at the inner circumferential portion, the storage life at the inner circumferential portion, the storage life at the outer circumferential portion, and the inner/outer circumferential amplitude ratio. Therefore, the overall evaluation was OK.

B7: The composition of the recording layer was Bi₁₉Ge₂₆Te₅₅. The target values were attained for all of the items. However, the evaluation was OK for the jitter at the inner circumferential portion, the rewriting life at the inner circumferential portion, the storage life at the inner circumferential portion, the storage life at the outer circumferential portion, and the inner/outer circumferential amplitude ratio. Therefore, the overall evaluation was OK.

B8: The composition of the recording layer was Bi₂₁Ge₂₄Te₅₅. The storage life at the inner circumferential portion did not attain the target value. Therefore, the overall evaluation was NG.

B9: The composition of the recording layer was Bi₂₅Ge₁₉Te₅₆. The storage life at the inner circumferential portion did not attain the target value. Therefore, the overall evaluation was NG.

As described above, all of the target values are attained by all of the information-recording media when the recording layer materials existing on the line for connecting Ge₅₀Te₅₀ and Bi₂Te₃ on the triangular composition diagram having the apexes corresponding to Bi, Ge, and Te are used and when the amount of Ge is 26 to 47%. In particular, it has been revealed that the extremely satisfactory performance is exhibited when the amount of Ge is 41 to 46%.

3. C Series

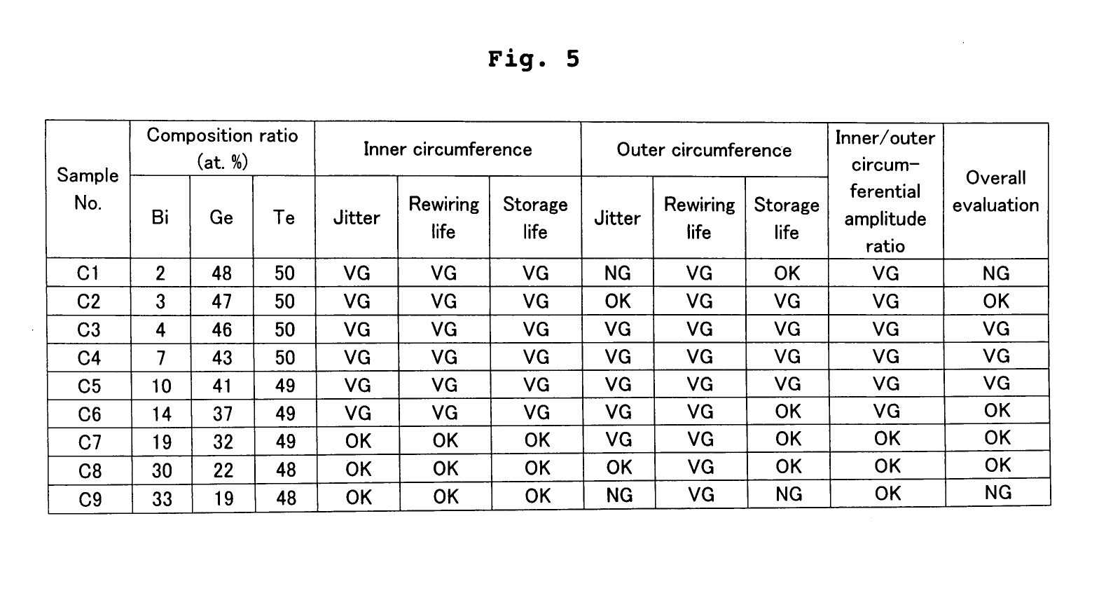

In C Series, information-recording media were prepared and evaluated, which contained recording layer materials added with excessive amounts of Ge as compared with those existing on the line for connecting Ge₅₀Te₅₀ and Bi₂Te₃ on the triangular composition diagram having the apexes corresponding to Bi, Ge, and Te. In this procedure, the recording layer material, which was subjected to the film formation with the sputtering target on the side of Bi—Te, had a composition of Bi₃₂Ge₂₀Te₄₈. An explanation will be made below with reference to FIG. 5 about results of the evaluation of the recording layers having the respective compositions.

C1: The composition of the recording layer was Bi₂Ge₄₈Te₅₀. The jitter at the outer circumferential portion did not attain the target value. Therefore, the overall evaluation was NG.

C2: The composition of the recording layer was Bi₃Ge₄₇Te₅₀. The target values were attained for all of the items. However, the evaluation was OK for the jitter at the outer circumferential portion. Therefore, the overall evaluation was OK.

C3: The composition of the recording layer was Bi₄Ge₄₆Te₅₀. The target values were sufficiently attained for all of the items. Therefore, the overall evaluation was VG.

C4: The composition of the recording layer was Bi₇Ge₄₃Te₅₀. The target values were sufficiently attained for all of the items. Therefore, the overall evaluation was VG.

C5: The composition of the recording layer was Bi₁₀Ge₄₁Te₄₉. The target values were sufficiently attained for all of the items. Therefore, the overall evaluation was VG.

C6: The composition of the recording layer was Bi₁₄Ge₃₇Te₄₉. The target values were attained for all of the items. However, the evaluation was OK for the storage life at the outer circumferential portion. Therefore, the overall evaluation was OK.

C7: The composition of the recording layer was Bi₁₉Ge₃₂Te₄₉. The target values were attained for all of the items. However, the evaluation was OK for the jitter at the inner circumferential portion, the rewriting life at the inner circumferential portion, the storage life at the inner circumferential portion, the storage life at the outer circumferential portion, and the inner/outer circumferential amplitude ratio. Therefore, the overall evaluation was OK.

C8: The composition of the recording layer was Bi₃₀Ge₂₂Te₄₈. The target values were attained for all of the items. However, the evaluation was OK for the jitter at the inner circumferential portion, the rewriting life at the inner circumferential portion, the storage life at the inner circumferential portion, the jitter at the outer circumferential portion, the storage life at the outer circumferential portion, and the inner/outer circumferential amplitude ratio. Therefore, the overall evaluation was OK.

C9: The composition of the recording layer was Bi₃₃Ge₁₉Te₄₈. The jitter at the outer circumferential portion and the storage life at the outer circumferential portion did not attain the target values. Therefore, the overall evaluation was NG.

As described above, all of the target values are attained by all of the information-recording media when the recording layer materials having the compositions obtained by adding the appropriate amounts of excessive Ge to the recording layer materials existing on the line for connecting Ge₅₀Te₅₀ and Bi₂Te₃ on the triangular composition diagram having the apexes corresponding to Bi, Ge, and Te are used and when the amount of Ge is 22 to 47%. In particular, it has been revealed that the extremely satisfactory performance is exhibited when the amount of Ge is 41 to 46%.

4. D Series

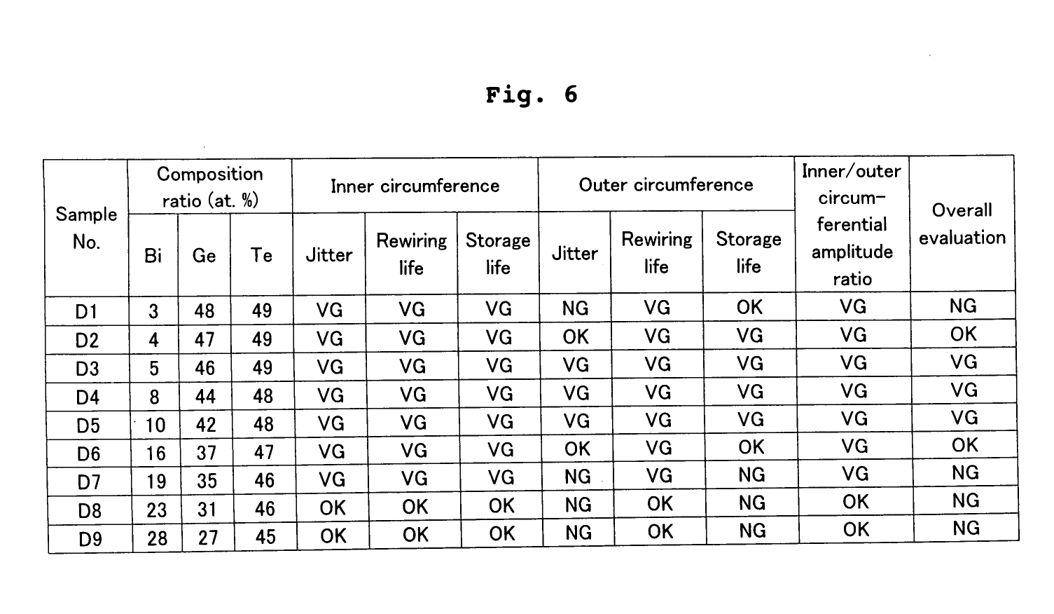

In D Series, information-recording media were prepared and evaluated, which contained recording layer materials further added with excessive amounts of Ge as compared with those existing on the composition line of C Series on the triangular composition diagram having the apexes corresponding to Bi, Ge, and Te. In this procedure, the recording layer material, which was subjected to the film formation with the sputtering target on the side of Bi—Te, had a composition of Bi₃₀Ge₂₆Te₄₄. An explanation will be made below with reference to FIG. 6 about results of the evaluation of the recording layers having the respective compositions.

D1: The composition of the recording layer was Bi₃Ge₄₈Te₄₉. The jitter at the outer circumferential portion did not attain the target value. Therefore, the overall evaluation was NG.

D2: The composition of the recording layer was Bi₄Ge₄₇Te₄₉. The target values were attained for all of the items. However, the evaluation was OK for the jitter at the outer circumferential portion. Therefore, the overall evaluation was OK.

D3: The composition of the recording layer was Bi₅Ge₄₆Te₄₉. The target values were sufficiently attained for all of the items. Therefore, the overall evaluation was VG.

D4: The composition of the recording layer was Bi₈Ge₄₄Te₄₈. The target values were sufficiently attained for all of the items. Therefore, the overall evaluation was VG.

D5: The composition of the recording layer was Bi₁₀Ge₄₂Te₄₈. The target values were sufficiently attained for all of the items. Therefore, the overall evaluation was VG.

D6: The composition of the recording layer was Bi₁₆Ge₃₇Te₄₇. The target values were attained for all of the items. However, the evaluation was OK for the jitter at the outer circumferential portion and the storage life at the outer circumferential portion. Therefore, the overall evaluation was OK.

D7: The composition of the recording layer was Bi₁₉Ge₃₅Te₄₆. The jitter at the outer circumferential portion and the storage life at the outer circumferential portion did not attain the target values. Therefore, the overall evaluation was NG.

D8: The composition of the recording layer was Bi₂₃Ge₃₁Te₄₆. The jitter at the outer circumferential portion and the storage life at the outer circumferential portion did not attain the target values. Therefore, the overall evaluation was NG.

D9: The composition of the recording layer was Bi₂₈Ge₂₇Te₄₅. The jitter at the outer circumferential portion and the storage life at the outer circumferential portion did not attain the target values. Therefore, the overall evaluation was NG.

As described above, all of the target values are attained by all of the information-recording media when the recording layer materials having the compositions obtained by adding the appropriate amounts of excessive Ge to the recording layer materials existing on the line for connecting Ge₅₀Te₅₀ and Bi₂Te₃ on the triangular composition diagram having the apexes corresponding to Bi, Ge, and Te in the same manner as in C Series are used and when the amount of Ge is 37 to 47%. In particular, it has been revealed that the extremely satisfactory performance is exhibited when the amount of Ge is 42 to 46%.

5. E Series

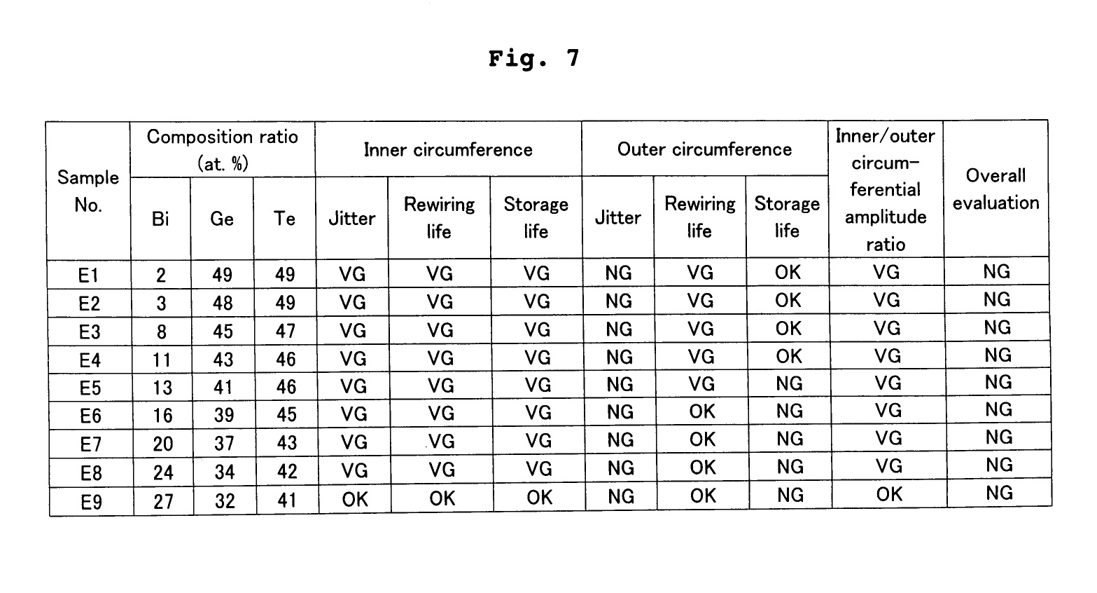

In E Series, information-recording media were prepared and evaluated, which contained recording layer materials added with further excessive amounts of Ge as compared with those existing on the composition line of D Series on the triangular composition diagram having the apexes corresponding to Bi, Ge, and Te. In this procedure, the recording layer material, which was subjected to the film formation with the sputtering target on the side of Bi—Te, had a composition of Bi₂₇Ge₃₂Te₄₁. An explanation will be made below with reference to FIG. 7 about results of the evaluation of the recording layers having the respective compositions.

E1: The composition of the recording layer was Bi₂Ge₄₉Te₄₉. The jitter at the outer circumferential portion did not attain the target value. Therefore, the overall evaluation was NG.

E2: The composition of the recording layer was Bi₃Ge₄₈Te₄₉. The jitter at the outer circumferential portion did not attain the target value. Therefore, the overall evaluation was NG.

E3: The composition of the recording layer was Bi₈Ge₄₅Te₄₇. The jitter at the outer circumferential portion did not attain the target value. Therefore, the overall evaluation was NG.

E4: The composition of the recording layer was Bi₁₁Ge₄₃Te₄₆. The jitter at the outer circumferential portion did not attain the target value. Therefore, the overall evaluation was NG.

E5: The composition of the recording layer was Bi₁₃Ge₄₁Te₄₆. The jitter at the outer circumferential portion and the storage life at the outer circumferential portion did not attain the target values. Therefore, the overall evaluation was NG.

E6: The composition of the recording layer was Bi₁₆Ge₃₉Te₄₅. The jitter at the outer circumferential portion and the storage life at the outer circumferential portion did not attain the target values. Therefore, the overall evaluation was NG.

E7: The composition of the recording layer was Bi₂₀Ge₃₇Te₄₃. The jitter at the outer circumferential portion and the storage life at the outer circumferential portion did not attain the target values. Therefore, the overall evaluation was NG.

E8: The composition of the recording layer was Bi₂₄Ge₃₄Te₄₂. The jitter at the outer circumferential portion and the storage life at the outer circumferential portion did not attain the target values. Therefore, the overall evaluation was NG.

E9: The composition of the recording layer was Bi₂₇Ge₃₂Te₄₁. The jitter at the outer circumferential portion and the storage life at the outer circumferential portion did not attain the target values. Therefore, the overall evaluation was NG.

As described above, the overwrite performance is suddenly deteriorated at the outer circumferential portion when the recording layer materials having the compositions obtained by adding the excessive amounts of excessive Ge to the recording layer materials existing on the line for connecting Ge₅₀Te₅₀ and Bi₂Te₃ on the triangular composition diagram having the apexes corresponding to Bi, Ge, and Te are used. Therefore, it was revealed that the information-recording media were not practical for the CAV recording.

6. Optimum Composition Range of Recording Layer Material

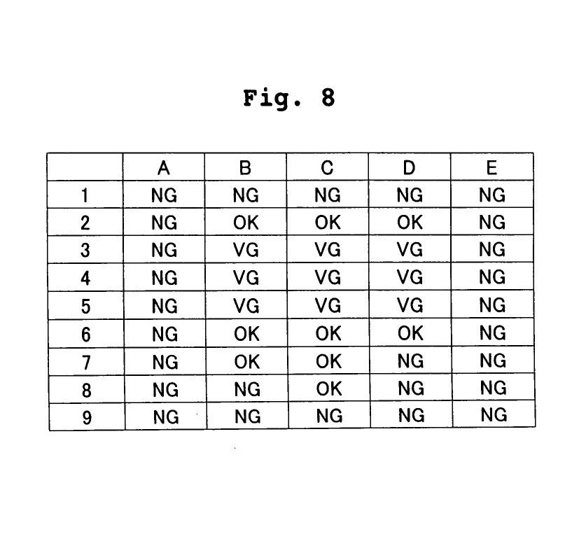

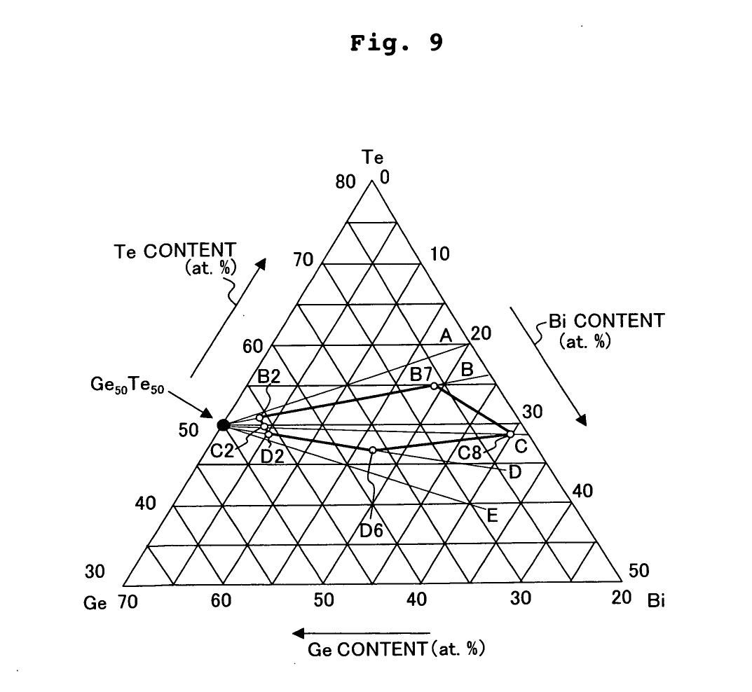

The results of the overall evaluation in the first embodiment as described above are summarized in FIG. 8. On the basis of the results, a composition range, in which the overall evaluation is OK, is shown in a triangular composition diagram in FIG. 9. That is, the composition range is surrounded by the following composition points:

B2 (Bi₂, Ge₄₇, Te₅₁);

C2 (Bi₃, Ge₄₇, Te₅₀);

D2 (Bi₄, Ge₄₇, Te₄₉);

D6 (Bi₁₆, Ge₃₇, Te₄₇);

C8 (Bi₃₀, Ge₂₂, Te₄₈);

B7 (Bi₁₉, Ge₂₆, Te₅₅).

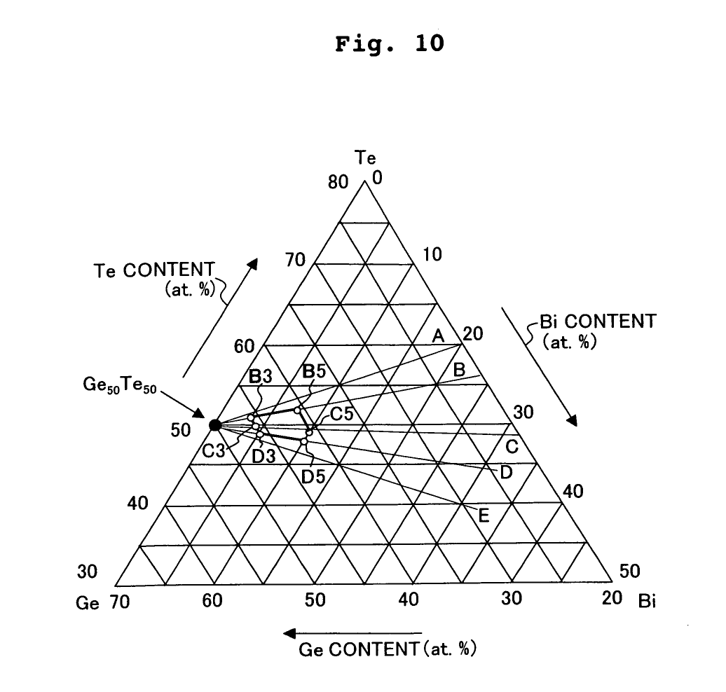

Further, a composition range, in which the extremely satisfactory performance is exhibited for all of the evaluation items and the overall evaluation is VG, is shown in FIG. 10. That is, the composition range is surrounded by the following composition points:

B3 (Bi₃, Ge₄₆, Te₅₁);

C3 (Bi₄, Ge₄₆, Te₅₀);

D3 (Bi₅, Ge₄₆, Te₄₉);

D5 (Bi₁₀, Ge₄₂, Te₄₈);

C5 (Bi₁₀, Ge₄₁, Te₄₉);

B5 (Bi₇, Ge₄₁, Te₅₂).

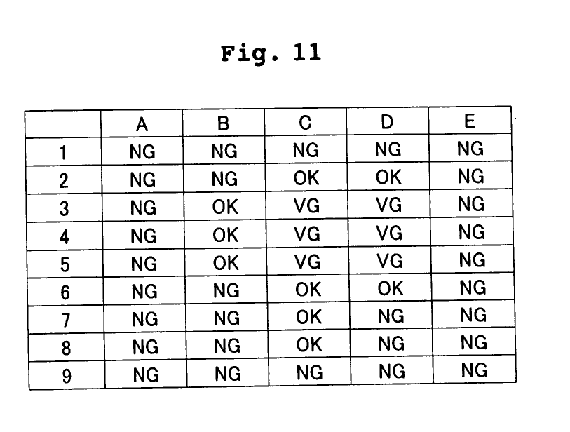

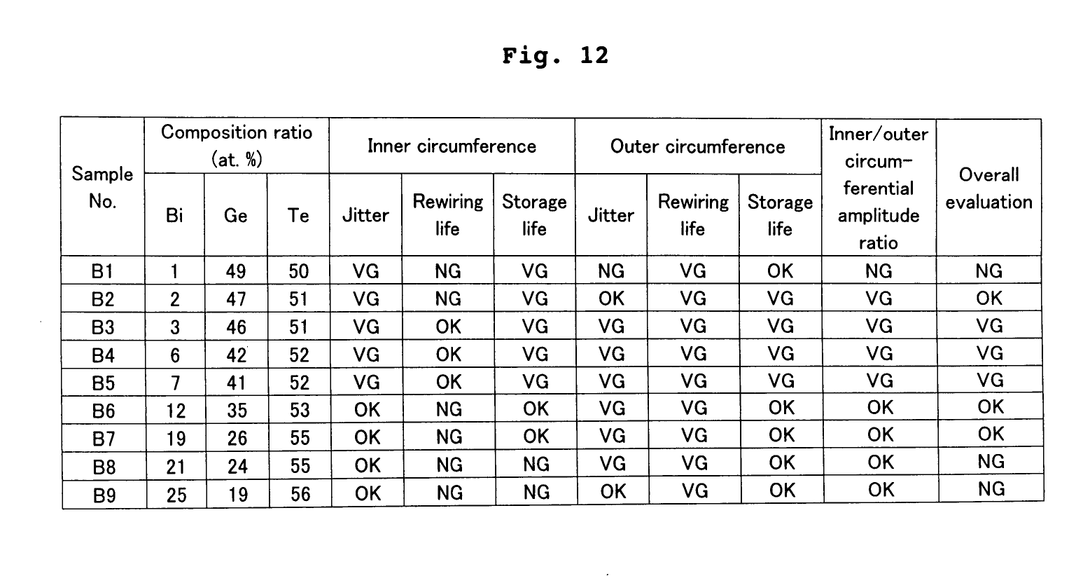

Results of the overall evaluation, which were obtained when the rewriting was performed multiple times, i.e., 100,000 times on each of the disks, are shown in FIG. 11. The judgment criteria are the same as those adopted when the rewriting was performed multiple times, i.e., 10,000 times. As clarified from the comparison with FIG. 8, the overall evaluation of B series is deteriorated. The cause of this fact is clarified from the evaluation results of the respective evaluation items for B Series as shown in FIG. 12. When the rewriting is performed multiple times, i.e., 100,000 times on the media of B Series, the evaluation of VG is obtained under all conditions for the rewriting life at the outer circumferential portion in the same manner as in the case in which the rewriting is performed 10,000 times (FIG. 4). On the contrary, when the rotation was effected at the linear velocity corresponding to that at the inner circumferential portion to perform the rewriting multiple times, i.e., 100,000 times, the target values were not attained on all of the media. It has been revealed that those of B Series are practical in the case of the number of rewriting of about 10,000 times, but they are not practical for the way of use in which the number of rewriting of multiple times, i.e., about 100,000 times is required.

7. F Series

As described above, when the composition ratios of Bi, Ge, and Te contained in the recording layer are within the range in which Ge exists in the excessive amount as compared with those existing on the line for connecting GeTe (Ge₅₀Te₅₀) and Bi₂Te₃, Ge tends to segregate at the outer edge of the melted area during the recording. The crystallization speed of Ge is extremely slow as compared with those of the Te compounds and Bi as described above. As a result, the crystallization speed is slow at the outer edge of the melted area, and consequently it is possible to suppress the recrystallization from the outer edge of the melted area. In particular, owing to the successful suppression of the recrystallization, it is possible to suppress the signal deterioration which would be otherwise caused by the segregation of the recording film composition after the multiple times rewriting. Therefore, when the excessive Ge exists even in a slight amount, the effect of the present invention is expressed. Experimental results of F Series are shown below by way of example.

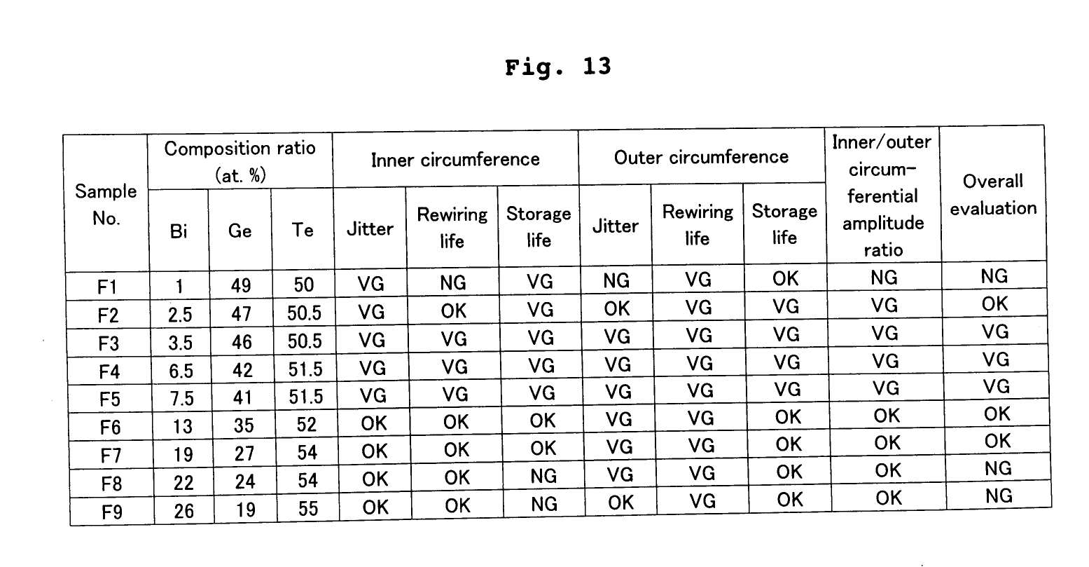

In F Series, recording layer materials having compositions, in which the composition ratios of Bi, Ge, and Te were positioned between those of B Series and those of C Series, were used. That is, information-recording media were prepared and evaluated, which contained recording layer materials existing on the line for connecting Ge₅₀Te₅₀ and Bi₂Te₃ on the triangular composition diagram having the apexes corresponding to Bi, Ge, and Te. In this procedure, the recording layer material, which was subjected to the film formation with the sputtering target on the side of Bi—Te, had a composition of Bi₃₈Ge₅Te₅₇. When the evaluation of the rewriting life was performed, then the rewriting was performed 100,000 times, and the judgment was made in accordance with the judgment criteria described above. An explanation will be made with reference to FIG. 13 about results of the evaluation of the recording layers having the respective compositions.

F1: The composition of the recording layer was Bi₁Ge₄₉Te₅₀. The rewriting life at the inner circumferential portion, the jitter at the outer circumferential portion, and the inner/outer circumferential amplitude ratio did not attain the target values. Therefore, the overall evaluation was NG.

F2: The composition of the recording layer was Bi_{2.5}Ge₄₇Te_{50.5}. The target values were attained for all of the items. However, the evaluation was OK for the rewriting life at the inner circumferential portion and the jitter at the outer circumferential portion. Therefore, the overall evaluation was OK.

F3: The composition of the recording layer was Bi_{3.5}Ge₄₆Te_{50.5}. The target values were sufficiently attained for all of the items. Therefore, the overall evaluation was VG.

F4: The composition of the recording layer was Bi_{6.5}Ge₄₂Te_{51.5}. The target values were sufficiently attained for all of the items. Therefore, the overall evaluation was VG.

F5: The composition of the recording layer was Bi_{7.5}Ge₄₁Te_{1.5}. The target values were sufficiently attained for all of the items. Therefore, the overall evaluation was VG.

F6: The composition of the recording layer was Bi₁₃Ge₃₅Te₅₂. The target values were attained for all of the items. However, the evaluation was OK for the jitter at the inner circumferential portion, the rewriting life at the inner circumferential portion, the storage life at the inner circumferential portion, the storage life at the outer circumferential portion, and the inner/outer circumferential amplitude ratio. Therefore, the overall evaluation was OK.

F7: The composition of the recording layer was Bi₁₉Ge₂₇Te₅₄. The target values were attained for all of the items. However, the evaluation was OK for the jitter at the inner circumferential portion, the rewriting life at the inner circumferential portion, the storage life at the inner circumferential portion, the storage life at the outer circumferential portion, and the inner/outer circumferential amplitude ratio. Therefore, the overall evaluation was OK.

F8: The composition of the recording layer was Bi₂₂Ge₂₄Te₅₄. The storage life at the inner circumferential portion did not attain the target value. Therefore, the overall evaluation was NG.

F9: The composition of the recording layer was Bi₂₈Ge₁₉Te₅₅. The storage life at the inner circumferential portion did not attain the target value. Therefore, the overall evaluation was NG.

As described above, all of the target values are attained by all of the information-recording media when the recording layer materials having the compositions obtained by adding the appropriate amounts of excessive Ge to the recording layer materials existing on the line for connecting Ge₅₀Te₅₀ and Bi₂Te₃ on the triangular composition diagram having the apexes corresponding to Bi, Ge, and Te in the same manner as in C Series are used and when the amount of Ge is 27 to 47%. In particular, it has been revealed that the extremely satisfactory performance is exhibited when the amount of Ge is 41 to 46%.

8. Optimum Composition Range of Recording Layer Material Having Multiple Times Rewriting Life of 100,000 Times

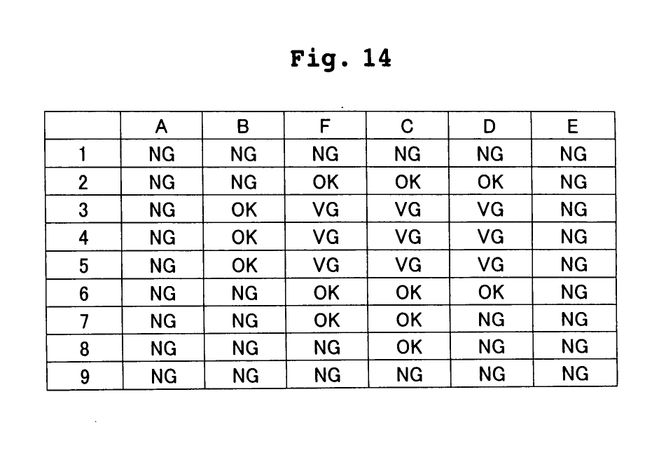

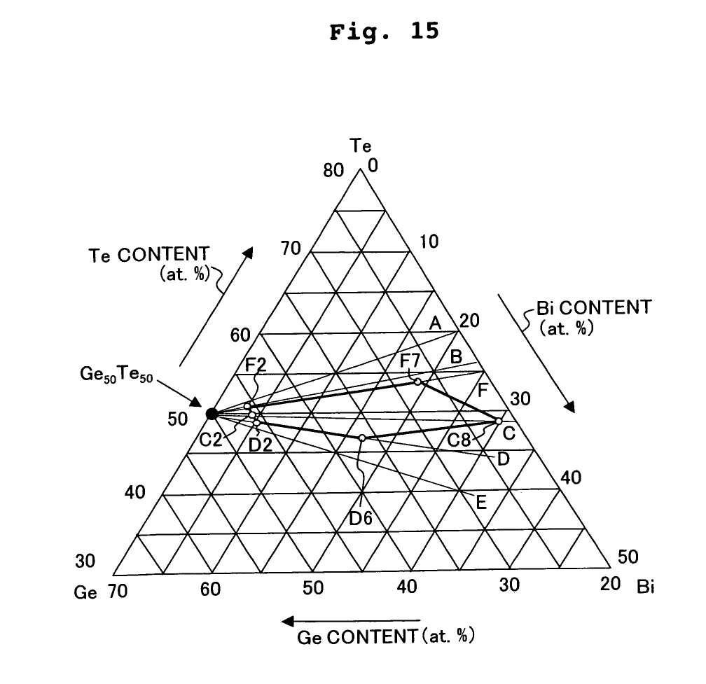

The results of the overall evaluation in the embodiment as described above are summarized in FIG. 14. On the basis of the results, a composition range, in which the overall evaluation is OK, is shown in a triangular composition diagram in FIG. 15. That is, the composition range is surrounded by the following composition points:

F2 (Bi_{2.5}, Ge₄₇, Te_{50.5});

C2 (Bi₃, Ge₄₇, Te₅₀);

D2 (Bi₄, Ge₄₇, Te₄₉);

D6 (Bi₁₆, Ge₃₇, Te₄₇);

C8 (Bi₃₀, Ge₂₂, Te₄₈);

F7 (Bi₁₉, Ge₂₇, Te₅₄).

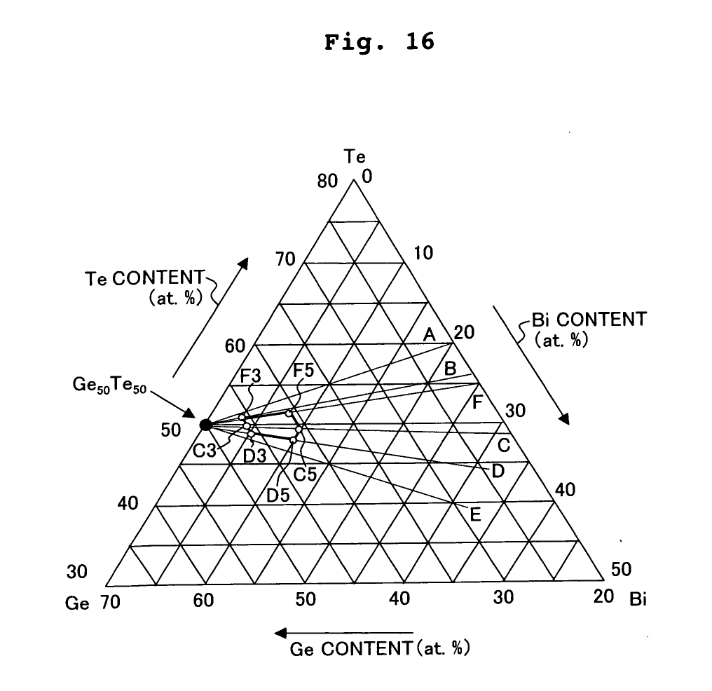

Further, a composition range, in which the extremely satisfactory performance is exhibited for all of the evaluation items and the overall evaluation is VG, is shown in FIG. 16. That is, the composition range is surrounded by the following composition points:
F3 (Bi_{3.5}, Ge₄₆, Te_{50.5});
C3 (Bi₄, Ge₄₆, Te₅₀);
D3 (Bi₅, Ge₄₆, Te₄₉);
D5 (Bi₁₀, Ge₄₂, Te₄₈);
C5 (Bi₁₀, Ge₄₁, Te₄₉);
F5 (Bi_{7.5}, Ge₄₁, Te_{51.5}).

### Optimum Structure

An explanation will be made about the optimum compositions and the optimum film thicknesses of the respective layers to be used for the information-recording medium of the present invention.

First Protective Layer

The substance, which exists on the light-incoming side or the side of the first protective layer on which the light comes thereinto, is a plastic substrate such as polycarbonate or an organic matter such as ultraviolet-curable resin. The refractive index of such a substance is about 1.4 to 1.6. In order to effectively cause the reflection between the organic matter and the first protective layer, it is desirable that the refractive index of the first protective layer is not less than 2.0. It is preferable, from optical viewpoints, that the first protective layer has the refractive index which is not less than that of the substance existing on the light-incoming side (corresponding to the substrate in this embodiment), and the refractive index is large within a range in which no light absorption is caused. Specifically, it is desirable to use a material which does not absorb the light and which has a refractive index n between 2.0 and 3.0, especially containing oxide, carbide, nitride, sulfide, and/or selenide of metal. It is desirable that the coefficient of thermal conductivity is at least not more than 2 W/mk. In particular, ZnS—SiO₂-based compounds have low coefficients of thermal conductivity, which are most appropriate for the first protective layer. Further, SnO₂, materials obtained by adding sulfide such as ZnS, CdS, SnS, GeS, and PbS to SnO₂, and materials obtained by adding transition metal oxide such as Cr₂O₃ and Mo₃O₄ to SnO₂ especially exhibit excellent characteristics as the first protective layer, because they are not dissolved into the recording film even when the film thickness of the first thermostable layer is not more than 2 nm, because they have low coefficients of thermal conductivity, and they are thermally stable as compared with ZnS—SiO₂-based materials. In order to effectively utilize the optical interference between the substrate and the recording layer, the optimum film thickness of the first protective layer is 110 nm to 145 nm when the wavelength of the laser is about 650 nm.

First Thermostable Layer

The melting point of the phase-change recording layer material of the present invention is at a high temperature, i.e., not less than 650° C. Therefore, it is desirable to provide the first thermostable layer which is extremely thermally stable between the first protective layer and the recording layer. Specifically, high melting point oxides, high melting point nitrides, and high melting point carbides including, for example, Cr₂O₃, Ge₃N₄, and SiC are thermally stable. It is appropriate to use a material which does not cause any deterioration due to exfoliation of the film even in the case of the long term storage. When a material such as Bi, Sn, and Pb, which facilitates the crystallization of the recording layer, is contained in the first thermostable layer, an effect is obtained to suppress the recrystallization of the recording layer, which is more desirable. In particular, it is desirable to use Te compounds and/or oxides of Bi, Sn, and Pb, mixtures of germanium nitride and Te compounds and/or oxides of Bi, Sn, and Pb, and mixtures of transition metal oxides, transition metal nitrides, and Te compounds and/or oxides of Bi, Sn, and Pb, for the following reason. That is, the transition metal changes the number of valences with ease. Therefore, even when the element such as Bi, Sn, Pb, and Te is liberated, then the transition metal changes the number of valences, and the bonding is formed between the transition metal and Bi, Sn, Pb, and Te to produce a thermally stable compound. In particular, Cr, Mo, and W are excellent materials, because they have high melting points, they change the number of valences with ease, and they tend to produce thermally stable compounds together with the metal as described above. It is preferable that the contents of the Te compounds and/or oxides of Bi, Sn, and Pb in the first thermostable layer are favorably as large as possible in order to facilitate the crystallization of the recording layer. However, the first thermostable layer is apt to be at a high temperature brought about by being irradiated with the laser beam, as compared with the second thermostable layer. A problem arises, for example, such that the material for the thermostable layer is dissolved in the recording film. Therefore, it is necessary that the contents of the Te compounds and/or oxides of Bi, Sn, and Pb are suppressed to be at least not more than 70%.

When the film thickness of the first thermostable layer is not less than 0.5 nm, the effect is exhibited. However, if the film thickness is not more than 2 nm, then the first protective layer material is dissolved in the recording layer through the first thermostable layer, and the quality of the reproduced signal is deteriorated after the rewriting multiple times in some cases. Therefore, it is desirable that the film thickness is not less than 2 nm. On the other hand, if the film thickness of the first thermostable layer is thick, i.e., not less than 10 nm, any optically harmful influence is exerted. Therefore, any bad effect is caused, including, for example, the decrease of the reflectance and the decrease of the signal amplitude. Therefore, it is preferable that the film thickness of the first thermostable layer is not less than 2 nm and not more than 10 nm.

Recording Layer

As described above, when the composition of the Bi—Ge—Te-based phase-change recording layer material is surrounded by the following composition points B2, C2, D2, D6, C8, and B7, the adaptable linear velocity range can be adjusted with ease by adding appropriate amounts of Si, Sn, and/or Pb in place of Ge. For example, when Ge is substituted with Si, SiTe, which has a high melting point and a small crystallization speed as compared with Ge and GeTe, is produced. Therefore, SiTe is segregated at the outer edge of the melted portion, and the recrystallization is suppressed. When GeTe is substituted with SnTe and/or PbTe, the nucleus-generating velocity is improved. Therefore, it is possible to replenish the insufficient erasing during the high speed recording.

B2 (Bi₂, Ge₄₇, Te₅₁);

C2 (Bi₃, Ge₄₇, Te₅₀);

D2 (Bi₄, Ge₄₇, Te₄₉);

D6 (Bi₁₆, Ge₃₇, Te₄₇);

C8 (Bi₃₀, Ge₂₂, Te₄₈);

B7 (Bi₁₉, Ge₂₆, Te₅₅).

That is, the recording layer materials having the following composition systems are available.

4-element recording layer material: Bi—Ge—Si—Te, Bi—Ge—Sn—Te, Bi—Ge—Pb—Te;

5-element recording layer material: Bi—Ge—Si—Sn—Te, Bi—Ge—Si—Pb—Te, Bi—Ge—Sn—Pb—Te;

6-element recording layer material: Bi—Ge—Si—Sn—Pb—Te.

When the multi-element composition is adopted as described above, it is possible to more finely control the performance of the recording layer material.

Further, when B is added to the recording layer material to be used for the information-recording medium of the present invention, it is possible to obtain the information-recording medium which exhibits excellent performance in which the recrystallization is further suppressed, probably for the following reason. That is, it is considered that B has the effect to suppress the recrystallization in the same manner as Ge, but the segregation is successfully caused quickly, because the B atom is extremely small.

The effect of the present invention is not lost even when any impurity makes contamination provided that the atomic % of the impurity is within 1%, on condition that the recording layer material to be used for the information-recording medium of the present invention maintains the relationship within the range represented by the foregoing composition formulas.

It is optically optimum that the film thickness of the recording layer is not less than 5 nm and not more than 15 nm in the medium structure of the present invention. In particular, when the film thickness is not less than 7 nm and not more than 11 nm, then the deterioration of the reproduced signal, which would be otherwise caused by the flowing of the recording film during the multiple times rewriting, is suppressed, and the modulation degree can be made optically optimum, which is convenient.

Second Thermostable Layer

The melting point of the phase-change recording layer material of the present invention is at a high temperature, i.e., not less than 650° C. in the same manner as in the first thermostable layer. Therefore, it is desirable that the second thermostable layer, which is extremely thermally stable, is provided between the second protective layer and the recording layer. Specifically, high melting point oxides, high melting point nitrides, and high melting point carbides including, for example, Cr₂O₃, Ge₃N₄, and SiC are thermally stable. It is appropriate to use a material which does not cause any deterioration due to exfoliation of the film even in the case of the long term storage. When a material such as Bi, Sn, and Pb, which facilitates the crystallization of the recording layer, is contained in the second thermostable layer, an effect is obtained to suppress the recrystallization of the recording layer, which is more desirable.

In particular, it is desirable to use Te compounds and/or oxides of Bi, Sn, and Pb, mixtures of germanium nitride and Te compounds and/or oxides of Bi, Sn, and Pb, and mixtures of transition metal oxides, transition metal nitrides, and Te compounds and/or oxides of Bi, Sn, and Pb, for the following reason. That is, the transition metal changes the number of valences with ease. Therefore, even when the element such as Bi, Sn, Pb, and Te is liberated, then the transition metal changes the number of valences, and the bonding is formed between the transition metal and Bi, Sn, Pb, and Te to produce a thermally stable compound. In particular, Cr, Mo, and W are excellent materials, because they have high melting points, they change the number of valences with ease, and they tend to produce thermally stable compounds together with the metal as described above. It is preferable that the contents of the Te compounds and/or oxides of Bi, Sn, and Pb in the first thermostable layer are favorably as large as possible in order to facilitate the crystallization of the recording layer. However, the first thermostable layer is apt to be at a high temperature brought about by being irradiated with the laser beam, as compared with the second thermostable layer. A problem arises, for example, such that the material for the thermostable layer is dissolved in the recording film. Therefore, it is necessary that the contents of the Te compounds and/or oxides of Bi, Sn, and Pb are suppressed to be at least not more than 70%.

When the film thickness of the second thermostable layer is not less than 0.5 nm, the effect is exhibited. However, if the film thickness is not more than 1 nm, then the second protective layer material is dissolved in the recording layer through the second thermostable layer, and the quality of the reproduced signal is deteriorated after the rewriting multiple times in some cases. Therefore, it is desirable that the film thickness is not less than 1 nm. On the other hand, if the film thickness of the second thermostable layer is thicker than 5 nm, any optically harmful influence is exerted. Therefore, any bad effect is caused, including, for example, the decrease of the reflectance and the decrease of the signal amplitude. Therefore, it is preferable that the film thickness of the second thermostable layer is not less than 1 nm and not more than 5 nm.

Second Protective Layer

It is desirable that the second protective layer is composed of a material which does not absorb the light, and especially the second protective layer contains oxide, carbide, nitride, sulfide, and/or selenide of metal. It is desirable that the coefficient of thermal conductivity is not more than at least 2 W/mk. In particular, ZnS—SiO₂-based compounds have low coefficients of thermal conductivity, which are most appropriate for the second protective layer. Further, SnO₂, materials obtained by adding sulfide such as ZnS, CdS, SnS, GeS, and PbS to SnO₂, and materials obtained by adding transition metal oxide such as Cr₂O₃ and Mo₃O₄ to SnO₂ especially exhibit excellent characteristics as the second protective layer, because they are not dissolved into the recording film even when the film thickness of the second thermostable layer is not more than 1 nm, because they have low coefficients of thermal conductivity, and they are thermally stable as compared with ZnS—SiO₂-based materials. In order to effectively utilize the optical interference between the recording layer and the absorptance control layer, the optimum film thickness of the second protective layer is 25 nm to 45 nm when the wavelength of the laser is about 650 nm.

Absorptance Control Layer

As for the absorptance control layer, it is preferable that the complex refractive index n, k is within ranges of 1.4<n<4.5 and −3.5<k<−0.5. In particular it is desirable to use a material which satisfies 2<n<4 and −3.0<k<−0.5. It is preferable to use a thermally stable material, because the absorptance control layer absorbs the light. Desirably, it is required that the melting point is not less than 1,000° C. When sulfide is added to the protective layer, an especially large effect to reduce the cross-erase was obtained. However, in the case of the absorptance control layer, it is desirable that the content of the sulfide such as ZnS is at least smaller than the content of the sulfide to be added at least to the protective layer as described above, for the following reason. That is, harmful influences sometimes appear, for example, such that the melting point is lowered, the coefficient of thermal conductivity is lowered, and the absorptance is lowered. The composition of the absorptance control layer desirably resides in a mixture of metal and metal oxide, metal sulfide, metal nitride, and/or metal carbide. A mixture of Cr and Cr₂O₃ exhibited an especially satisfactory effect to improve the overwrite characteristics. In particular, when Cr is contained by 60 to 95 atomic %, it is possible to obtain a material having the coefficient of thermal conductivity and the optical constant suitable for the present invention. Specifically, those desirably usable as the metal include Al, Cu, Ag, Au, Pt, Pd, Co, Ti, Cr, Ni, Mg, Si, V, Ca, Fe, Zn, Zr, Nb, Mo, Rh, Sn, Sb, Te, Ta, W, Ir, and Pb as mixture. Those preferably useable as the metal oxide, the metal sulfide, the metal nitride, and the metal carbide include SiO₂, SiO, TiO₂, Al₂O₃, Y₂O₃, CeO, La₂O₃, In₂O₃, GeO, GeO₂, PbO, SnO, SnO₂, Bi₂O₃, TeO₂, MO₂, WO₂, WO₃, Sc₂O₃, Ta₂O₅, and ZrO₂. Other than the above, it is also allowable to use the absorptance control layer which is based on the use of oxides including, for example, Si—O—N materials, Si—Al—O—N materials, Cr—O materials such as Cr₂O₃, Co—O materials such as CO₂O₃ and CoO; nitrides including, for example, Si—N materials such as TaN, AlN, and Si₃N₄, Al—Si—N materials (for example, AlSiN₂), and Ge—N materials; sulfides including, for example, ZnS, Sb₂S₃, CdS, In₂S₃, Ga₂S₃, GeS, SnS₂, PbS, and Bi₂S₃; selenides including, for example, SnSe₃, Sb₂Se₃, CdSe, ZnSe, In₂Se₃, Ga₂Se₃, GeSe, GeSe₂, SnSe, PbSe, and Bi₂Se₃; fluorides including, for example, CeF₃, MgF₂, and CaF₂; and those having compositions similar to those of the materials described above.

The film thickness of the absorptance control layer is desirably not less than 10 nm and not more than 100 nm. When the film thickness is not less than 20 nm and not more than 50 nm, an especially satisfactory effect to improve the overwrite characteristic appears. When the sum of the film thicknesses of the protective layer and the absorptance control layer is not less than the groove depth, an effect to reduce the cross-erase remarkably appears. As explained above, the absorptance control layer has the property to absorb the light. Therefore, the absorptance control layer also absorbs the light to generate the heat similarly to the recording layer which absorbs the light to generate the heat. It is important that the absorptance of the absorptance control layer, which is obtained when the recording layer is in the amorphous state, is larger than that obtained when the recording layer is in the crystalline state. When the optical design is made as described above, an effect is expressed such that the absorptance Aa in the recording layer, which is obtained when the recording layer is in the amorphous state, is smaller than the absorptance Ac of the recording layer which is obtained when the recording layer is in the crystalline state. Owing to this effect, it is possible to greatly improve the overwrite characteristics. In order to obtain the characteristics as described above, it is necessary that the absorptance in the absorptance control layer is raised to be about 30 to 40%. The amount of heat generation in the absorptance control layer differs depending on whether the state of the recording layer is the crystalline state or the amorphous state. As a result, the flow of the heat, which is directed from the recording layer to the heat-diffusing layer, changes depending on the state of the recording layer. Owing to this phenomenon, it is possible to suppress the increase of the jitter which would be otherwise caused by the overwrite.

The foregoing effect is expressed by such an effect that the flow of the heat directed from the recording layer to the heat-diffusing layer is shut off in accordance with the increase in temperature of the absorptance control layer. In order to effectively make the use of this effect, it is preferable that the sum of the film thicknesses of the protective layer and the absorptance control layer is not less than the difference in level between the land and the groove (groove depth on the substrate, about 1/7 to ⅕ of the laser wavelength). If the sum of the film thicknesses of the protective layer and the absorptance control layer is not more than the difference in level between the land and the groove, then the heat, which is generated when the recording is performed in the recording layer, is transmitted through the heat-diffusing layer, and the recording mark recorded on the adjoining track tends to be erased.

Heat-Diffusing Layer

As for the heat-diffusing layer, it is preferable to use a metal or an alloy having a high reflectance and a high coefficient of thermal conductivity. It is desirable that the total content of Al, Cu, Ag, Au, Pt, and Pd is not less than 90 atomic %. A material such as Cr, Mo, and W having a high melting point and a large hardness as well as an alloy of such a material is also preferred, because it is possible to avoid the deterioration which would be otherwise caused by the flowing of the recording layer material during the multiple times rewriting. In particular, when the heat-diffusing layer contains Al by not less than 95 atomic %, it is possible to obtain the information-recording medium which is cheap, which has high CNR, which has high recording sensitivity, which is excellent in multiple times rewriting durability, and which has an extremely large effect to reduce the cross-erase. In particular, when the composition of the heat-diffusing layer contains Al by not less than 95 atomic %, it is possible to realize the information-recording medium which is cheap and which is excellent in corrosion resistance. The element to be added to Al includes Co, Ti, Cr, Ni, Mg, Si, V, Ca, Fe, Zn, Zr, Nb, Mo, Rh, Sn, Sb, Te, Ta, W, Ir, Pb, B, and C which are excellent in corrosion resistance. However, when the added element is Co, Cr, Ti, Ni, and/or Fe, a large effect is especially obtained to improve the corrosion resistance. It is preferable that the film thickness of the heat-diffusing layer is not less than 30 nm and not more than 100 nm. If the film thickness of the heat-diffusing layer is thinner than 30 nm, then the recording layer tends to be deteriorated especially when the rewriting is performed about 100,000 times, and the cross-erase tends to occur in some cases, because the heat, which is generated in the recording layer, is hardly diffused. In this case, the light is transmitted. Therefore, such a heat-diffusing layer is hardly used, and the reproduced signal amplitude is lowered in some cases. When the metal element contained in the absorptance control layer is the same as the metal element contained in the heat-diffusing layer, a great advantage is obtained in view of the production, for the following reason. That is, it is possible to form the films of the two layers of the absorptance control layer and the heat-diffusing layer by using an identical target. In other words, the sputtering is performed with a mixed gas such as Ar—O₂ mixed gas and Ar—N₂ mixed gas during the film formation of the absorptance control layer, and the metal element is reacted with oxygen or nitrogen during the sputtering to prepare the absorptance control layer having an appropriate refractive index. The sputtering is performed with Ar gas during the film formation of the heat-diffusing layer to prepare the metal heat-diffusing layer having a high coefficient of thermal conductivity.

If the film thickness of the heat-diffusing layer is not less than 200 nm, then the productivity is inferior, and any warpage or the like of the substrate occurs due to the internal stress of the heat-diffusing layer. As a result, it is impossible to correctly record and reproduce information in some cases. When the film thickness of the heat-diffusing layer is not less than 30 nm and not more than 90 nm, the corrosion resistance and the productivity are excellent, which is more desired.

### Second Embodiment

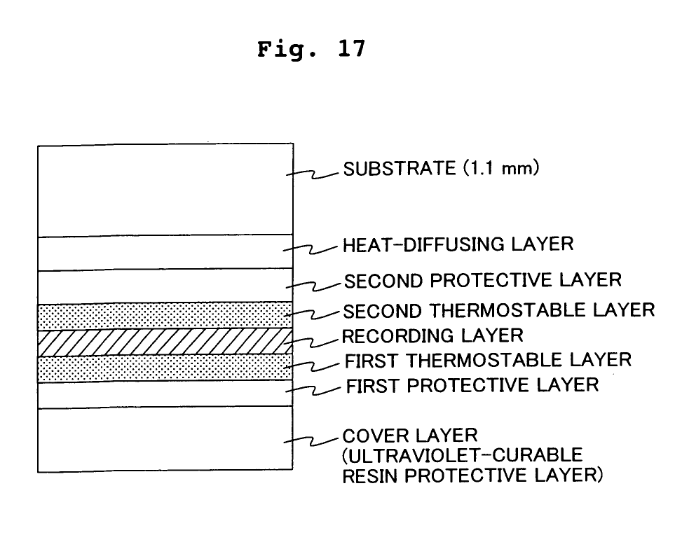

Next, an explanation will be made with reference to FIG. 17 about a second embodiment of the present invention in which the recording is performed with a blue laser.

### Medium Structure

FIG. 17 shows a basic structure of an information-recording medium of the present invention. That is, the structure comprises a heat-diffusing layer, a second protective layer, a second thermostable layer, a recording layer, a first thermostable layer, and a first protective layer which are successively stacked on a substrate, and a cover layer is finally formed. In this embodiment, a substrate having a thickness of 1.1 mm made of polycarbonate is used as the substrate. The substrate, which was used, had grooves formed at a track pitch of 0.32 μm within a range ranging from an inner circumferential position of 23.8 mm to an outer circumferential position of 58.6 mm of the recording area.

Films of Ag₉₈Ru₁Au₁ (% by weight) of 100 nm as the heat-diffusing layer, (ZnS)₈₀(SiO₂)₂₀ of 30 nm as the second protective layer, Ge₈₀Cr₂₀—N of 2 nm as the second thermostable layer, the recording layer of 12 nm as described later on, Ge₈₀Cr₂₀—N of 2 nm as the first thermostable layer, and (ZnS)₈₀(SiO₂)₂₀ of 60 nm as the first protective layer were formed on the substrate having the thickness of 1.1 mm by means of the sputtering process. Further, an ultraviolet-curable resin layer was uniformly applied to have a thickness of 0.1 mm by means of the spin coat method. The ultraviolet-curable resin layer was cured by being irradiated with ultraviolet light, and thus the cover layer was formed to obtain the information-recording medium used in the second embodiment as described below. The recording layer material will be explained in detail later on.

The disk manufactured as described above was initialized by irradiating the disk with a laser beam having a wavelength of 810 nm and having an elliptical beam with a beam long diameter of 96 μm and a short diameter of 1 μm.

In this embodiment, the manufactured disk had such a structure that the layers were stacked in the order reverse to that used for the conventional products such as DVD-RAM. However, the effect of the present invention is not lost even in the case of a structure in which the layers are stacked in the same order as that used in the conventional technique.

No problem arises when any absorptance control layer is stacked, if necessary.

### Recording and Reproduction Conditions in this Embodiment

The recording and reproduction conditions adopted in the present invention will be explained below. The CAV system, in which the number of revolutions of the disk is changed for every zone, is adopted as the method for controlling the motor.

When the information is recorded on the information-recording medium (hereinafter referred to as “optical disk”), the mark edge system is used to perform the recording by using the (1-7) RLL modulation system. The clock frequency was 66 MHz at the inner circumference during the recording of the information. The clock frequency was increased as the linear velocity was increased. The linear velocity at the inner circumference was 5.28 m/s. The initialized disk was rotated. A semiconductor laser beam having a wavelength of 405 nm was collected with an objective lens having a numerical aperture of 0.85 via the cover layer. The information was recorded and reproduced in the on-groove manner while performing the tracking control in accordance with the push-pull system. The term “on-groove” herein refers to the area which is disposed on the nearer side as viewed from the optical head, of the concave/convex structure formed on the substrate. The multi-pulse recording waveform, in which the recording pulse was divided into a plurality of pieces, was used to form the recording mark. A laser beam, which was at an intermediate power level capable of effecting the recrystallization, was firstly radiated, and then a laser beam, which was at a high power level to obtain the amorphous state, was radiated at every clock cycle T. A laser beam, which was at a low power level, was radiated in the period between the respective high power level pulses. Cooling pulses at a low power level were radiated immediately after the radiation of the final pulse of the series of high power level pulses, and then the laser power level was returned to the intermediate laser power level which was capable of effecting the crystallization. When the mark having a length of nT (n: 2 to 8) was formed, then the number of high power pulses was n−1, and the pulse width was appropriately optimized depending on, for example, the recording layer material and the linear velocity. The high power laser power was 5 mW, the intermediate power was 1.5 mW, and the low power level was 0.3 mW. However, these powers were also appropriately optimized depending on, for example, the recording layer material and the linear velocity.

In general, when the laser beam having the laser wavelength λ is collected by the lens having the lens numerical aperture NA, the spot diameter of the laser beam is about 0.9×λ/NA. Therefore, on the condition as described above, the spot diameter of the laser beam is about 0.43 μm. In this procedure, the laser beam was circularly polarized.

When the recording is performed on the optical disk under the condition as described above, then the mark length of the 2T mark as the shortest mark is about 0.160 μm, and the mark length of the 8T mark as the longest mark is about 0.64 μm.

When the jitter is measured, then random pattern signals including 2T to 8T were recorded and reproduced, and reproduced signals were subjected to the processing of waveform equivalence based on the use of a conventional equalizer, waveform equivalence based on the use of a limit equalizer, binary conversion, and PLL (Phase Locked Loop) to measure the jitter with a time interval analyzer (TIA).

### Evaluation Criteria for Recording Layer Material

In order to evaluate the signal quality and the recording erasing performance at the inner circumferential portion and the outer circumferential portion, the jitters (jitters after recording the random signal ten times) were measured at the recording linear velocities corresponding to those at the inner circumferential portion and the outer circumferential portion. In this measurement of the jitter, the random pattern was recorded in an order in a direction from the inner circumference to the outer circumference of continuous 5 tracks, and then the jitter was measured on the center track of the 5 tracks. In order to test the rewriting life, the jitters were measured after 10,000 times rewriting at the recording linear velocities corresponding to those at the inner circumferential portion and the outer circumferential portion respectively to measure the amounts of increase from the jitters obtained after 10 times recording. The jitters after 100,000 times rewriting were also measured in the same manner as described above to measure the amounts of increase from the jitters obtained after 10 times recording. Further, in order to evaluate the influence of the recrystallization in the recording mark recorded at the recording linear velocity corresponding to that at the inner circumferential portion, a single frequency signal of 8 T was recorded at the recording linear velocity corresponding to that at the inner circumferential portion and at the recording linear velocity corresponding to that at the outer circumferential portion to measure the inner/outer circumferential amplitude ratio (amplitude at inner circumferential portion/amplitude at outer circumferential portion). An acceleration test was performed in order to evaluate the storage life. Specifically, a random signal was recorded 10 times at the linear velocity corresponding to that at the inner circumferential portion on a measurement objective medium to measure the jitter beforehand. The difference from the amount of increase of jitter was measured after being left to stand for 20 hours in an oven heated to 90° C. (so-called archival reproduction jitter). Further, the jitter was measured beforehand after recording a random signal 10 times at the recording linear velocity corresponding to that at the outer circumferential portion on a different track simultaneously with the test described above. The overwrite was performed only once on the same track after being maintained for 20 hours at a temperature of 90° C. to measure the difference from the jitter obtained before the acceleration test (so-called archival overwrite jitter). Target values for the respective performances are as follows.

Jitter: not more than 7%;

Rewriting life: not more than 2%;

Inner/outer circumferential amplitude ratio: not less than 0.8;

Storage life (inner circumference): not more than 2%;

Storage life (outer circumference): not more than 3%.

The target value of 7% of the jitter is large as compared with the standard value (not more than 6%). However, as explained above, no change is made for the structure other than the composition of the recording layer, because only the performance of the recording layer is compared for the information-recording medium to be used in this embodiment. Therefore, the increase of the jitter of at least not less than 1% occurs as compared with a case in which the medium is constructed in a suitable manner for each of the recording layers. Accordingly, the target value is intentionally raised. However, when the medium was optimally constructed for each of several recording layer compositions in which the jitter was not more than 7% in this test, the jitter was lowered to be not more than 6% for all of the media. Therefore, the target value described above is reasonable to judge the performance of the recording layer composition. As for the evaluation of the recrystallization amount, it was assumed that the inner/outer circumferential amplitude ratio was not less than 0.8. However, the recrystallization was sufficiently suppressed in the information-recording medium which had achieved the target values as described above. Therefore, the problems did not occur, including the deterioration of the cross-erase performance at the innermost circumferential portion, the deterioration of the cross speed overwrite performance, the deterioration of the cross speed crosstalk performance, and the deterioration of the cross speed cross-erase performance. On the other hand, the probability to cause any one of the foregoing problems was particularly increased in the information-recording medium which did not achieve the target values as described above. Therefore, the target values described above are reasonable.

Results of the evaluation in this embodiment are expressed by VG (very good), OK, and NG (no good), wherein the following judgment criteria are adopted.

Jitter

VG: not more than 7%, OK: not more than 8%, NG: more than 8%.

Rewriting Life

VG: not more than 1%, OK: not more than 2%, NG: more than 2%.

Inner/Outer Circumferential Amplitude Ratio

VG: not less than 0.9, OK: not less than 0.8, NG: less than 0.8.

Storage Life (Inner Circumference)

VG: not more than 1%, OK: not more than 2%, NG: more than 2%.

Storage Life (Outer Circumference)

VG: not more than 2%, OK: not more than 3%, NG: more than 3%.

Overall Evaluation

VG: all of the forgoing evaluation items were VG;

OK: NG was absent in the forgoing evaluation items, and at least one OK was present;

NG: NG was present in at least one of the foregoing evaluation items.

### Method for Forming Recording Layer

The recording layer was formed as the film in accordance with the same method as that used in the first embodiment.

### Results of Evaluation of Recording Layer Materials

The recording layers of A to F Series were investigated in the same manner as in the first embodiment, and results were obtained in the same manner as in the first embodiment.

In this embodiment, the on-groove recording was performed at the track pitch of 0.32 μm. However, the same or equivalent results were obtained even when the land-groove recording was performed.

In this embodiment, the CAV recording system has been described by way of example. However, the same or equivalent results were obtained even when the CLV recording system was adopted.

As described in the first embodiment, when the composition of the Bi—Ge—Te-based phase-change recording layer material is surrounded by the following composition points B2, C2, D2, D6, C8, and B7, then Si, Sn, and/or Pb as the homologous elements may be used in place of Ge. The adaptable linear velocity range can be adjusted with ease by adding appropriate amounts of Si, Sn, and/or Pb in place of Ge. For example, when Ge is substituted with Si, SiTe, which has a high melting point and a small crystallization speed as compared with Ge and GeTe, is produced. Therefore, SiTe is segregated at the outer edge of the melted portion, and the recrystallization is suppressed. When GeTe is substituted with SnTe and/or PbTe, the nucleus-generating velocity is improved. Therefore, it is possible to replenish the insufficient erasing during the high speed recording.

B2 (Bi₂, Ge₄₇, Te₅₁);

C2 (Bi₃, Ge₄₇, Te₅₀);

D2 (Bi₄, Ge₄₇, Te₄₉);

D6 (Bi₁₆, Ge₃₇, Te₄₇);

C8 (Bi₃₀, Ge₂₂, Te₄₈);

B7 (Bi₁₉, Ge₂₆, Te₅₅).

That is, the recording layer materials having the following composition systems are available.

4-element recording layer material: Bi—Ge—Si—Te, Bi—Ge—Sn—Te, Bi—Ge—Pb—Te;

5-element recording layer material: Bi—Ge—Si—Sn—Te, Bi—Ge—Si—Pb—Te, Bi—Ge—Sn—Pb—Te;

6-element recording layer material: Bi—Ge—Si—Sn—Pb—Te.

When the multi-element composition is adopted as described above, it is possible to more finely control the performance of the recording layer material.

Further, when B is added to the recording layer material to be used for the information-recording medium of the present invention, it is possible to obtain the information-recording medium which exhibits excellent performance in which the recrystallization is further suppressed, probably for the following reason. That is, it is considered that B has the effect to suppress the recrystallization in the same manner as Ge, but the segregation is successfully caused quickly, because the B atom is extremely small.

The effect of the present invention is not lost even when any impurity makes contamination provided that the atomic % of the impurity is within 1%, on condition that the recording layer material to be used for the information-recording medium of the present invention maintains the relationship within the range represented by the foregoing composition formulas.

It is optically optimum that the film thickness of the recording layer is not less than 5 nm and not more than 15 nm in the medium structure of the present invention. In particular, when the film thickness is not less than 7 nm and not more than 11 nm, then the deterioration of the reproduced signal, which would be otherwise caused by the flowing of the recording film during the multiple times rewriting, is suppressed, and the modulation degree can be made optically optimum, which is convenient.

According to the present invention, it is possible to obtain the information-recording medium which solves all of the following problems:

Problem 1: deterioration of the signal at the innermost circumferential portion during the CAV recording;

Problem 2: deterioration of the multiple times rewriting performance at the innermost circumferential portion during the CAV recording;

Problem 3: deterioration of the storage life at the innermost circumferential portion and the outermost circumferential portion during the CAV recording;

Problem 4: deterioration of the cross-erase performance at the innermost circumferential portion during the CAV recording;

Problem 5: deterioration of the cross speed overwrite performance;

Problem 6: deterioration of the cross speed crosstalk performance;

Problem 7: deterioration of the cross speed cross-erase performance; and

Problem 8: increase of the number of layers in order to secure the cross speed performance (addition of the nucleus-generating layer).

What is claimed is:

1. An information-recording medium, comprising:
a substrate;
a recording layer which is rewritable in accordance with phase-change caused by being irradiated with a laser beam; and
at least one other layer which is formed over the recording layer,
wherein the information-recording medium is recordable in a range from a high recording linear velocity to a low recording linear velocity, a ratio of the high recording linear velocity to the low recording linear velocity is not less than 2.4, the recording layer has a film thickness of not more than 15 nm, the recording layer contains Bi, Ge and Te, and composition ratios thereof are within a range surrounded by the following respective points on a triangular composition diagram having apexes corresponding to Bi, Ge and Te:
F2 (Bi_{2.5}, Ge₄₇, Te_{50.5});
C2 (Bi₃, Ge₄₇, Te₅₀);
D2 (Bi₄, Ge₄₇, Te₄₉);
D6 (Bi₁₆, Ge₃₇, Te₄₇);
C8 (Bi₃₀, Ge₂₂, Te₄₈);
F7 (Bi₁₉, Ge₂₇, Te₅₄).

2. The information-recording medium according to claim 1, wherein composition ratios of the recording layer are within a range surrounded by the following respective points on a triangular composition diagram having apexes corresponding to Bi, Ge and Te:
F3 (Bi_{3.5}, Ge₄₆, Te_{50.5});
C3 (Bi₄, Ge₄₆, Te₅₀);
D3 (Bi₅, Ge₄₆, Te₄₉);
D5 (Bi₁₀, Ge₄₂, Te₄₈);
C5 (Bi₁₀, Ge₄₁, Te₄₉);
F5 (Bi_{7.5}, Ge₄₁, Te_{51.5}).

3. The information-recording medium according to claim 1, wherein a number of revolutions of the information-recording medium is controlled in accordance with a CAV system so that information is recorded with the high recording linear velocity at an outermost circumference portion of the information-recording medium and is recorded with the low recording linear velocity at an innermost circumference portion of the information-recording medium.

4. The information-recording medium according to claim 3, wherein the low recording linear velocity is 8.2 m/sec.

5. The information-recording medium according to claim 1, wherein a number of revolutions of the information-recording medium is controlled in accordance with a CLV system.

6. The information-recording medium according to claim 5, wherein the low recording linear velocity is 8.2 m/sec.

7. The information-recording medium according to claim 1, wherein the substrate has a recording track formed thereon, and a pitch TP of the recording track is not more than 0.618 μm.

8. The information-recording medium according to claim 1, wherein the information-recording medium has a disk-shaped configuration, a groove is previously formed in a concentric form or in a spiral form on the substrate, at least one of the groove and a land between the grooves is used as a recording track, and at least one of the groove and the land is wobbled.

9. A recording method for recording information to an information-recording medium, comprising:
rotating the information-recording medium in a range from a high recording linear velocity to a low recording linear velocity, wherein a ratio of the high recording linear velocity to the low recording linear velocity is not less than 2.4; and
irradiating a laser beam on the information-recording medium to record the information,
wherein, the information-recording medium includes a substrate, a recording layer which is rewritable in accordance with phase-change caused by being irradiated with the laser beam and at least one other layer which is formed over the recording layer, the recording layer has a film thickness of not more than 15 nm, the recording layer contains Bi, Ge and Te, and composition ratios thereof are within a range surrounded by the following respective points on a triangular composition diagram having apexes corresponding to Bi, Ge and Te:
F2 (Bi_{2.5}, Ge₄₇, Te_{50.5})
C2 (Bi₃, Ge₄₇, Te₅₀);
D2 (Bi₄, Ge₄₇, Te₄₉);
D6 (Bi₁₆, Ge₃₇, Te₄₇);
C8 (Bi₃₀, Ge₂₂, Te₄₈);
F7 (Bi₁₉, Ge₂₇, Te₅₄).

10. The recording method according to claim 9, wherein, when rotating the information-recording medium, a number of revolutions of the information-recording medium is controlled in accordance with a CAV system so that information is recorded with the high recording linear velocity at an outermost circumference portion of the information-recording medium and is recorded with the low recording linear velocity at an innermost circumference portion of the information-recording medium.

11. The recording method according to claim 10, wherein the low recording linear velocity is 8.2 m/sec.

12. A recording method for recording information to an information-recording medium, comprising:
selecting a recording linear velocity of the information-recording medium in a range from a high recording linear velocity to a low recording linear velocity, wherein a ratio of the high recording linear velocity to the low recording linear velocity is not less than 2.4; and
recording information on the information-recording medium with the selected recording linear velocity,
wherein, the information-recording medium includes a substrate, a recording layer which is rewritable in accordance with phase-change caused by being irradiated with the laser beam and at least one other layer which is formed over the recording layer, the recording layer has a film thickness of not more than 15 nm, the recording layer contains Bi, Ge and Te, and composition ratios thereof are within a range surrounded by the following respective points on a triangular composition diagram having apexes corresponding to Bi, Ge and Te:
F2 (Bi_{2.5}, Ge₄₇, Te_{50.5});
C2 (Bi₃, Ge₄₇, Te₅₀);
D2 (Bi₄, Ge₄₇, Te₄₉);
D6 (Bi₁₆, Ge₃₇, Te₄₇);
C8 (Bi₃₀, Ge₂₂, Te₄₈);
F7 (Bi₁₉, Ge₂₇, Te₅₄).

13. The recording method according to claim 12, wherein, when recording information on the information-recording medium, a number of revolutions of the information-recording medium is controlled in accordance with a CLV system.

14. The recording method according to claim 13, wherein the low recording linear velocity is 8.2 m/sec.
